(19) United States
(12) Patent Application Publication
(10) Pub. No.: US 2009/0021673 A1
(43) Pub. Date: Jan. 22, 2009

(54) Liquid Crystal Display Device

(75) Inventors: Nobutaka Fukagawa, Kanagawa (JP); Katsumi Sasata, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/087,430

(22) PCT Filed: Jan. 25, 2007
(86) PCT No.: PCT/JP2007/051653

§ 371 Date: Jul. 3, 2008

(30) Foreign Application Priority Data
Jan. 26, 2006 (JP) 2006-017869

(51) Int. Cl. G02F 1/1335; B32B 5/00; G02B 27/28

(52) U.S. Cl. 349/96; 428/220; 428/334; 359/485

(57) ABSTRACT

A cellulose acylate film, which has an in-plane retardation (Re) and a retardation in a thickness direction (Rth) satisfying relations of equations (1) to (6) and has a thickness of 30 μm or greater but less than 70 μm:

20 nm<Re(548)<100 nm (1)

100 nm<Rth(548)<400 nm (2)

0.5≦Re(446)/Re(548)≦0.90 (3)

1.05≦Re(629)/Re(548)≦1.50 (4)

0.5≦Rth(446)/Rth(548)≦0.95 (5)

1.05≦Rth(629)/Rth(548)≦1.50 (6).

### TECHNICAL FIELD

The present invention relates to a cellulose acylate film having a low haze, excellent in wavelength dispersion characteristics of retardation and can be collected and recycled; and an optically compensatory sheet, polarizing plate and liquid crystal display device using the film.

### BACKGROUND ART

Cellulose acylate films have been used widely as a polarizing plate protective film for liquid crystal display devices because it has adequate water permeability and high optical isotropy (low retardation).

In recent years, there has been proposed a process of imparting retardation to a cellulose acylate film, thereby giving it an optically compensatory function in addition to a function as a polarizing plate protective film. For example, a process of adding a triazine compound having high planarity to a cellulose acylate, thereby causing development of retardation is disclosed in JP-A-2003-344655, while a process of stretching a film containing a cellulose acylate having a specific acyl substitution degree, thereby causing development of retardation is disclosed in JP-A-2003-170492.

With a recent eager demand for high definition display devices mainly for liquid crystal television, more precise retardation control of optically compensatory sheets have also be required.

### DISCLOSURE OF THE INVENTION

In optically compensatory sheets, wavelength dispersion of retardation is an important performance for compensating a tint change which occurs, depending on the viewing angle of a liquid display device.

A process of stretching a cellulose acylate film having a specific substituent and a specific substitution degree in a width direction, thereby giving the film a characteristic that the in-plane retardation of the film increases at a longer wavelength is disclosed in JP-A-2002-296422. This process however increases the haze of the film, resulting in deterioration of the contrast of a liquid crystal display device.

In JP-A-2003-14933, on the other hand, disclosed is a process of co-casting two dopes different in the composition of additives, thereby obtaining a cellulose acylate film having a reduced haze while maintaining the characteristic that the in-plane retardation of the film increases at a longer wavelength. This process however needs improvement because use of two dope solutions different in composition makes it difficult to collect and dissolve the used film in a solvent and provide it for recycling use.

In other words, cellulose acylate films already proposed do not have a low haze, excellent wavelength dispersion characteristics of retardation and reusability at the same time. There is accordingly a demand for the development of a cellulose acylate film capable of satisfying all of these performances.

An object of the invention is to provide a cellulose acylate film which has a low haze, is excellent in wavelength dispersion characteristics and can be recycled; and an optically compensatory sheet, polarizing plate and liquid crystal display device using the film.

The present inventors have carried out an extensive investigation. As a result, it has been found that the factors which govern the wavelength dispersion characteristics of a cellulose acylate film can be classified roughly into two, that is, (A) factors attributable to cellulose acylate and (B) factors attributable to additives such as ultraviolet absorber and plasticizer.

It has also been found that (A) a change in wavelength dispersion characteristics attributable to cellulose acylate corresponds to the degree of orientation of a main cellulose acylate chain and reverse dispersion characteristics can be heightened by improving the degree of orientation of the main chain. It is the common practice to stretch a conventional film at a high stretch ratio in order to improve the degree of orientation of the main chain. It however causes crazes in the film, thereby inevitably raising the haze of the film. The present inventors have found that employment of the below-described method (i) can improve the degree of orientation of the main chain without raising the haze of the film.

(i) It has conventionally been known that a stretching stress inside of the film is smaller than that on the film surface and therefore, the degree of orientation of the main chain is lower inside of the film than that of the film surface. When the thickness of the film is decreased, a stress travels uniformly in the thickness direction and the film as a whole is improved in the degree of orientation.

It has also been found that (ii) an increase in a ratio of ultraviolet absorbers having a melting point of 25° C. or less relative to the total amount of additives, particularly, ultraviolet absorbers can suppress a rise in the haze which will otherwise occur by stretching operation. The mechanism of it has however not been elucidated yet.

It has been found further that with regard to (B) a change in the wavelength dispersion characteristics attributable to the additives, an increase in the ratio of oil components in the ultraviolet absorbers increases the reverse dispersion characteristics of retardation without causing a large change in the transmission of the film in the ultraviolet region.

Investigation has been made with a view to overcoming the above-described problems, which leads to completion of the present invention. In short, the problems of the present invention are resolved by the below-described means.

[1] A cellulose acylate film, which has an in-plane retardation (Re) and a retardation in a thickness direction (Rth) satisfying relations of equations (1) to (6) and has a thickness of 30 μm or greater but less than 70 μm:

20 nm<Re(548)<100 nm (1)

100 nm<Rth(548)<400 nm (2)

0.5≦Re(446)/Re(548)≦0.90 (3)

1.05≦Re(629)/Re(548)≦1.50 (4)

0.5≦Rth(446)/Rth(548)≦0.95 (5)

1.05≦Rth(629)/Rth(548)≦1.50 (6).

[2] The cellulose acylate film as described in [1] above, which has a haze of from 0.1 or greater but not greater than 0.8.

[3] The cellulose acylate film as described in [1] or [2] above,

wherein assuming that a degree of in-plane orientation of a cellulose acylate molecular chain of an entire film thickness is Po and a degree of orientation of a cellulose acylate molecular chain in a thickness direction of the film is Pth, the Po and Pth satisfy relations of equations (7) and (8):

0.040≦Po≦0.10 (7)

0.12≦Pth≦0.40 (8).

[4] The cellulose acylate film as described in [3] above,

wherein a degree Po of in-plane orientation of a cellulose acylate molecular chain of a film surface and the degree Po of in-plane orientation of the cellulose acylate molecular chain of the entire film thickness satisfy relation of equation (9):

1≦[(Po of the film surface)/(Po of the entire film thickness)]≦1.5 (9).

[5] The cellulose acylate film as described in any of [1] to [4] above, which is obtained by stretching, at a stretch ratio of 1% or greater but not greater than 100%, a film containing a cellulose acylate having an acylation degree of 2.50 or greater but not greater than 2.90 in at least one of a traveling direction of the film and a direction perpendicular thereto.

[6] The cellulose acylate film as described in any of [1] to [5] above, wherein a cellulose acylate of the cellulose acylate film contains two or more acyl groups different in the number of carbon atoms, and assuming that an acyl group having the smallest number of carbon atoms is called Acyl group A and an acyl group having the largest number of carbon atoms is called Acyl group B, degrees of substitution of A and B satisfy relations of equations (10) and (11):

0.1≦(degree of substitution of Acyl group A)≦2.40 (10)

0.1≦(degree of substitution of Acyl group B)≦1.50 (11).

[7] The cellulose acylate film as described in [6] above,

wherein Acyl group B contains an aromatic structure.

[8] The cellulose acylate film as described in any of [1] to [7] above, which comprises a plurality of ultraviolet absorbers each having an absorption maximum within a wavelength range of from 250 nm or greater but not greater than 380 nm,

wherein the plurality of ultraviolet absorbers contain at least one ultraviolet absorber having a melting point of 25° C. or less, and

a percentage of an amount of the at least one ultraviolet absorber having a melting point of 25° C. or less is 80 mass % or greater but not greater than 100 mass % based on a total amount of the plurality of ultraviolet absorbers.

[9] An optically compensatory sheet, which comprises a cellulose acylate film as described in any of [1] to [8] above.

[10] The optically compensatory sheet as described in [9] above, which further comprises an optically anisotropic layer on the cellulose acylate film.

[11] A polarizing plate, which comprises:

a polarization film; and

two transparent protective films located on both sides of the polarization film,

wherein at least one of the two transparent protective films is an optically compensatory sheet as described in [9] or [10] above.

[12] A liquid crystal display device, which comprises:

a liquid crystal cell; and

two polarizing plates located on both sides of the liquid crystal cell,

wherein at least one of the two polarizing plates is a polarizing plate as described in [11] above.

[13] The liquid crystal display device as described in [12] above,

wherein a display mode of the liquid crystal display device is a VA mode.

[14] The liquid crystal display device as described in [12] above,

wherein a display mode of the liquid crystal display device is an OCB mode.

The present invention makes it possible to provide a cellulose acylate film which has a low haze, is excellent in wavelength dispersion characteristics and can be collected and recycled, an optically compensatory sheet, a polarizing plate, and a liquid crystal display device having a high contrast and less color shift at any viewing angle.

### BRIEF DESCRIPTION OF THE DRAWING

FIG. 1 is a schematic diagram illustrating one exemplary example of the liquid crystal display device of the present invention;

FIG. 2 is a schematic diagram illustrating another exemplary example of the liquid crystal display device of the present invention; and

FIG. 3 is a schematic diagram illustrating a further exemplary example of the liquid crystal display device of the present invention,

wherein 30 denotes upper-side polarizing plate; 31 denotes VA mode liquid crystal cell; 32 denotes lower-side polarizing plate; 33 denotes cellulose acylate film; 34 denotes polarizer; 1 denotes upper polarizing plate; 2 denotes direction of the absorption axis of upper polarizing plate; 5 denotes liquid-cell upper electrode substrate; 6 denotes orientation controlling direction of upper substrate; 7 denotes liquid crystal layer; 8 denotes liquid-cell lower electrode substrate; 9 denotes orientation controlling direction of lower substrate; 10 denotes liquid crystal display device; 12 denotes lower polarizing plate; 13 denotes direction of absorption axis of lower polarizing plate; 21 denotes VA mode liquid crystal cell; 24 denotes polarizer; 25 denotes optically compensatory sheet; 26 denotes protective film; 27 denotes polarizing plate; 28 denotes observer side; and 29 denotes backlight side.

### BEST MODE FOR CARRYING OUT THE INVENTION

The present invention will hereinafter be described specifically. The symbol “˜” as used herein means that a numeral before or after it is included as the lower limit or upper limit.

### [Cellulose Acylate Film]

The cellulose acylate film of the invention is characterized in that the Re and Rth satisfy specific relationships and its film thickness falls within a specific range, which will be described later.

The cellulose acylate film of the invention having such characteristics contains additives such as ultraviolet absorbers and it is preferably obtained by stretching a film in at least one of a traveling direction of the film and a direction perpendicular thereto. A cellulose acylate, additive and film forming method will hereinafter be described in the order of mention.

### (Cellulose Acylate)

As raw material cotton of a cellulose acylate to be used for the cellulose acylate film of the invention, known raw materials can be used (for example, Journal of Technical Disclosure of Japan Institute of Invention and Innovation, 2001-1745). The synthesis of the cellulose acylate can also be performed in a known manner (for example, Mokuzai Kagaku, pp. 180-190, written by Migita, et al., published by Kyoritsu Shuppan in 1968).

Although no particular limitation is imposed on the acyl group of the cellulose acylate, but use of an acetyl group, propionyl group or butyryl group is preferred. The degree of substitution of all the acyl groups is preferably from 2.50 to 2.90, more preferably from 2.50 to 2.80, especially preferably from 2.50 to 2.65. The term “degree of substitution of the acyl group” as used herein means a value calculated in accordance with ASTM D817.

The cellulose acylate contains two or more acyl groups which are different in the number of carbon atoms. Assuming that the acyl group having the smallest number of carbon atoms is called Acyl group A and the acyl group having the largest number of carbon atoms is called Acyl group B, it is preferred, in order to balance a reduction in the thermal expansion coefficient of the film with hydrophobicity thereof, that the degrees of substitution of substituents A and B satisfy the following relations of equations (10) and (11):

0.1≦(degree of substitution of Acyl group A)≦2.40 (10)

0.1≦(degree of substitution of Acyl group B)≦1.50 (11).

The degree of substitution of Acyl group A is more preferably 1.0 or greater but not greater than 2.40, most preferably 1.50 or greater but not greater than 2.40.

The degree of substitution of Acyl group B is more preferably 0.2 or greater but not greater than 1.50, most preferably 0.4 or greater but not greater than 1.20.

The substituent A is especially preferably an acetyl group. The number of carbon atoms of the substituent B is preferably 3 or greater but not greater than 22, more preferably 3 or greater but not greater than 16. The substituent B is preferably an aliphatic acyl group such as propynyl and butyryl or an acyl group having an aromatic structure such as benzoyl, with the latter being especially preferred.

When the substituent A and the substituent B are each an aliphatic acyl group, they preferably satisfy the following equations (III) and (IV):

2.50≦DS2+DS3+DS6≦2.85 (III)

0.33<DS6/(DS2+DS3+DS6) (IV)

wherein, DS2 represents the degree of substitution of the 2-acyl group, DS3 represents the degree of substitution of the 3-acyl group, and DS6 represents the degree of substitution of the 6-acyl group.

The (DS2+DS3+DS6) is more preferably 2.60 or greater but not greater than 2.80, most preferably 2.65 or greater but not greater than 2.75.

The DS6/(DS2+DS3+DS6) is more preferably 0.35 or greater, most preferably 0.37 or greater.

When the substituent A or B is an acyl group having an aromatic structure, they satisfy the following equations (V) and (VI):

2.50≦DS2+DS3+DS6≦2.85 (V)

0.30≦DS6/(DS2+DS3+DS6) (VI)

The (DS2+DS3+DS6) is more preferably 2.60 or greater but not greater than 2.80, most preferably 2.65 or greater but not greater than 2.75.

The DS6/(DS2+DS3+DS6) is more preferably 0.50 or greater, most preferably 0.70 or greater.

As the cellulose acylate, mixed acid esters having a fatty acid acyl group and a substituted or unsubstituted aromatic acyl group are especially preferred. Examples of the substituted or unsubstituted aromatic acyl groups include the groups represented by the following formula (A):

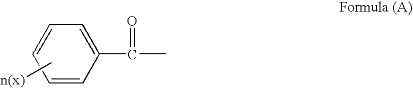

The formula (A) will next be described. In the formula (A), X represents a substituent. Examples of the substituent include a halogen atom, a cyano group, an alkyl group, an alkoxy group, an aryl group, an aryloxy group, an acyl group, a carbonamide group, a sulfonamide group, an ureido group, an aralkyl group, a nitro group, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an alkylsulfonyloxy group, an aryloxysulfonyl group, —S—R, —NH—CO—OR, —PH—R, —P(—R)₂, —PH—O—R, —P(—R)(—O—R), —P(—O—R)₂, —PH(═O)R—P(═O)(—R)₂, —PH(═O)—O—R, —P(═O)(—R)(—O—R), —P(═O)(—O—R)₂, —O—PH(═OR, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂ and —O—Si(—R)₃, in which R represents an aliphatic group, an aromatic group or a heterocyclic group.

In the formula (A), n stands for the number of substituents and is an integer of from 0 to 5. The number (n) of the substituents is preferably from 1 to 5, more preferably from 1 to 4, still more preferably from 1 to 3, most preferably 1 or 2. The above-described substituent is preferably a halogen atom, a cyano group, an alkyl group, an alkoxy group, an aryl group, an aryloxy group, an acyl group, a carbonamide group, a sulfonamide group or an ureido group, more preferably a halogen atom, a cyano group, an alkyl group, an alkoxy group, an aryloxy group, an acyl group, or a carbonamide group, still more preferably a halogen atom, a cyano group, an alkyl group, an alkoxy group, or an aryloxy group, most preferably a halogen atom, an alkyl group or an alkoxy group.

Examples of the halogen atom include a fluorine atom, a chlorine atom, a bromine atom and an iodine atom.

The alkyl group may have a cyclic structure or a branched structure. The alkyl group has preferably from 1 to 20 carbon atoms, more preferably from 1 to 12 carbon atoms, still more preferably from 1 to 6 carbon atoms, most preferably from 1 to 4 carbon atoms. Examples of the alkyl group include methyl, ethyl, propyl, isopropyl, butyl, tert-butyl, hexyl, cyclohexyl, actyl and 2-ethylhexyl.

The alkoxy group may have a cyclic structure or a branched structure. The alkoxy group has preferably from 1 to 20 carbon atoms, more preferably from 1 to 12 carbon atoms, still more preferably from 1 to 6 carbon atoms, most preferably from 1 to 4 carbon atoms. The alkoxy group may be further substituted with another alkoxy group. Examples of the alkoxy group include methoxy, ethoxy, 2-methoxyethoxy, 2-methoxy-2-ethoxyethoxy, butyloxy, hexyloxy and octyloxy.

The aryl group has preferably from 6 to 20 carbon atoms, more preferably from 6 to 12 carbon atoms. Examples of the aryl group include phenyl and naphthyl.

The aryloxy group has preferably from 6 to 20 carbon atoms, more preferably from 6 to 12 carbon atoms. Examples of the aryloxy group include phenoxy and naphthoxy.

The acyl group has preferably from 1 to 20 carbon atoms, more preferably from 1 to 12 carbon atoms. Examples of the acyl group include formyl, acetyl and benzoyl.

The carbonamide group has preferably from 1 to 20 carbon atoms, more preferably from 1 to 12 carbon atoms. Examples of the carbonamide group include acetamide and benzamide.

The sulfonamide group has preferably from 1 to 20 carbon atoms, more preferably from 1 to 12 carbon atoms. Examples of the sulfonamide group include methanesulfonamide, benzenesulfonamide and p-toluenesulfonamide.

The ureido group has preferably from 1 to 20 carbon atoms, more preferably from 1 to 12 carbon atoms. Examples of the ureido group include (unsubstituted) ureido.

The aralkyl group has preferably from 7 to 20 carbon atoms, more preferably from 7 to 12 carbon atoms. Examples of the aralkyl group include benzyl, phenethyl and naphthylmethyl.

The alkoxycarbonyl group has preferably from 2 to 20 carbon atoms, more preferably from 2 to 12 carbon atoms. Examples of the alkoxycarbonyl group include methoxycarbonyl.

The aryloxycarbonyl group has preferably from 7 to 20 carbon atoms, more preferably from 7 to 12 carbon atoms. Examples of the aryloxycarbonyl group include phenoxycarbonyl.

The aralkyloxycarbonyl group has preferably from 8 to 20 carbon atoms, more preferably from 8 to 12 carbon atoms. Examples of the aralkyloxycarbonyl group include benzyloxycarbonyl.

The carbamoyl group has preferably from 1 to 20 carbon atoms, more preferably from 1 to 12 carbon atoms. Examples of the carbamoyl group include (unsubstituted) carbamoyl and N-methylcarbamoyl.

The sulfamoyl group has preferably 20 or less carbon atoms, more preferably 12 or less carbon atoms. Examples of the sulfamoyl group include (unsubstituted) sulfamoyl and N-methylsulfamoyl.

The acyloxy group has preferably from 1 to 20 carbon atoms, more preferably from 2 to 12 carbon atoms. Examples of the acyloxy group include acetoxy and benzoyloxy.

The alkenyl group has preferably from 2 to 20 carbon atoms, more preferably from 2 to 12 carbon atoms. Examples of the alkenyl group include vinyl, allyl and isopropenyl.

The alkynyl group has preferably from 2 to 20 carbon atoms, more preferably from 2 to 12 carbon atoms. Examples of the alkynyl group include thienyl.

The alkylsulfonyl group has preferably from 1 to 20 carbon atoms, more preferably from 1 to 12 carbon atoms.

The arylsulfonyl group has preferably from 6 to 20 carbon atoms, more preferably from 6 to 12 carbon atoms.

The alkyloxysulfonyl group has preferably from 1 to 20 carbon atoms, more preferably from 1 to 12 carbon atoms.

The aryloxysulfonyl group has preferably from 6 to 20 carbon atoms, more preferably from 6 to 12 carbon atoms.

The alkylsulfonyloxy group has preferably from 1 to 20 carbon atoms, more preferably from 1 to 12 carbon atoms.

When the aromatic ring has two or more substituents, they may be the same or different, or may be mutually bonded to form a condensed polycyclic compound (such as naphthalene group, indene group, indane group, phenanthrene group, quinoline group, isoquinoline group, chromene group, chromane group, phthalazine group, acridine group, indole group or indoline group).

The aromatic acyl group can usually be substituted for the hydroxyl group of cellulose by a method utilizing a symmetric acid anhydride or a mixed acid anhydride derived from an aromatic carboxylic acid chloride or an aromatic carboxylic acid. A method utilizing an acid anhydride derived from an aromatic carboxylic acid is particularly preferred (described in Journal of Applied Polymer Science, 29, 3981-3990 (1984)).

Examples of the manufacturing process of a cellulose acylate, that is, a mixed acid ester compound of cellulose according to the invention include (i) a process of once preparing a fatty acid monoester or diester of cellulose and then introducing the aromatic acyl group, represented by formula (A), into remaining hydroxyl groups, or (ii) a method of reacting mixed acid anhydrides of an aliphatic carboxylic acid and an aromatic carboxylic acid directly with cellulose.

In the method (i), the preparation process of a fatty acid monoester or diester of cellulose is a known method, but a subsequent reaction of introducing the aromatic acyl group thereinto varies depending on the kind of the aromatic acyl group. The reaction temperature is preferably from 0 to 100° C., more preferably from 20 to 50° C., and the reaction time is preferably 30 minutes or greater, more preferably from 30 to 300 minutes.

The reaction conditions of the process (ii) using the mixed acid anhydrides also vary depending on the kind of the mixed acid anhydrides. The reaction temperature is preferably from 0 to 100° C., more preferably from 20 to 50° C., and the reaction time is preferably from 30 to 300 minutes, more preferably from 60 to 200 minutes. Each of these reactions may be performed in a solvent or in a solventless manner, but preferably in a solvent. Examples of the solvent usable for the reaction include dichloromethane, chloroform and dioxane.

Specific examples (Nos. 1 to 51) of the aromatic acyl group represented by formula (A) will be described below, but the present invention is not limited thereto. As the aromatic acyl group represented by formula (A), Nos. 1, 3, 5, 6, 8, 13, 18 and 28 are preferred, with Nos. 1, 3, 6 and 13 being more preferred.

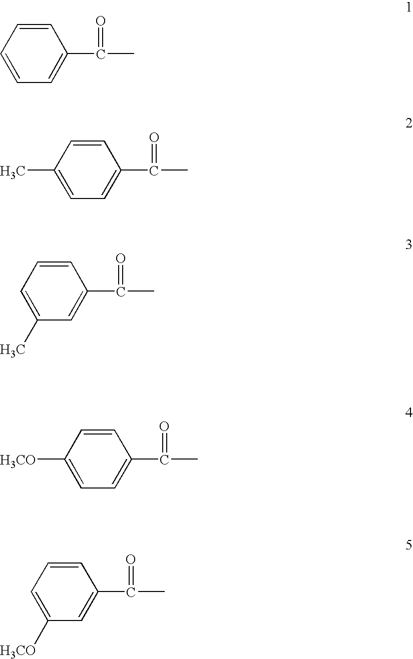

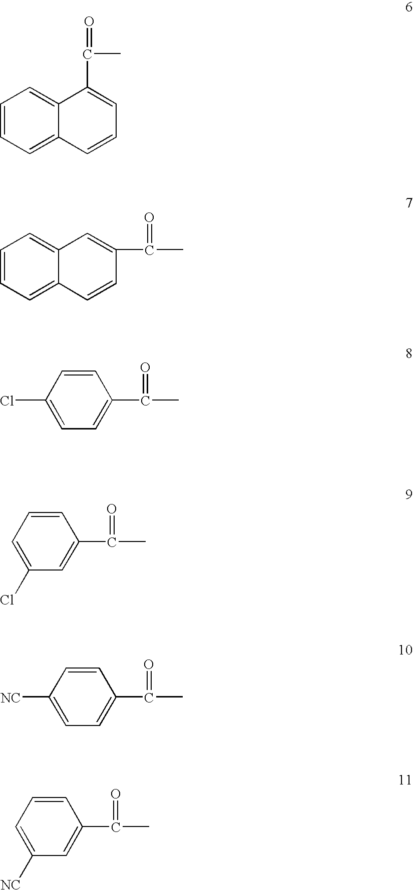

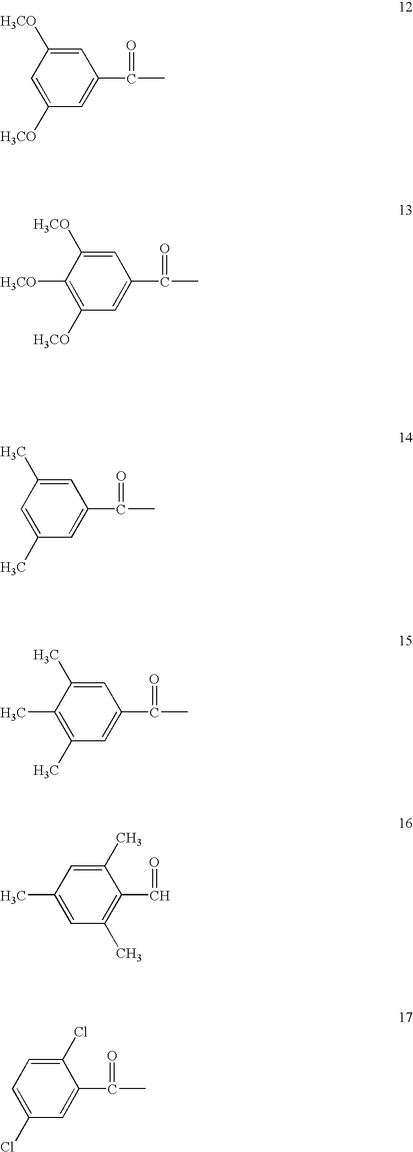

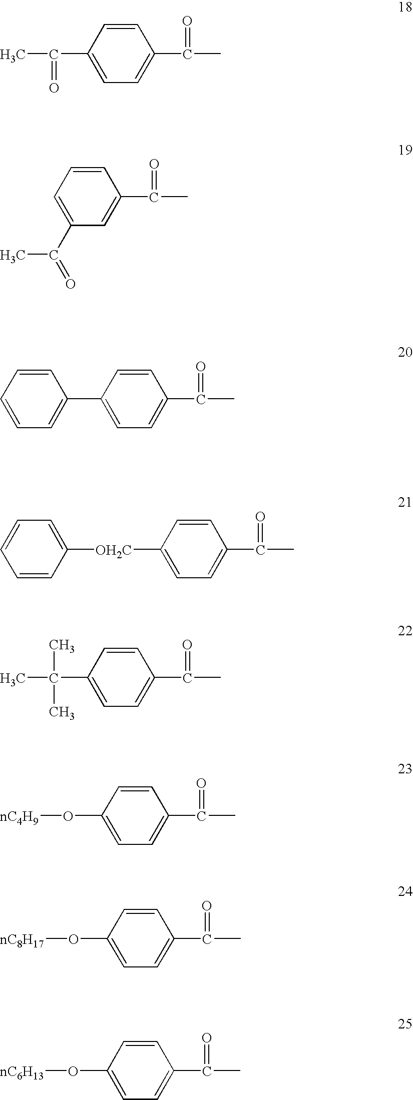

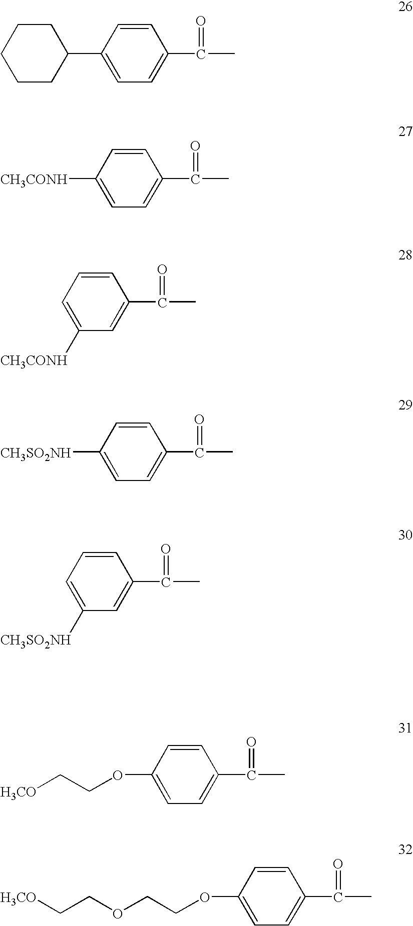

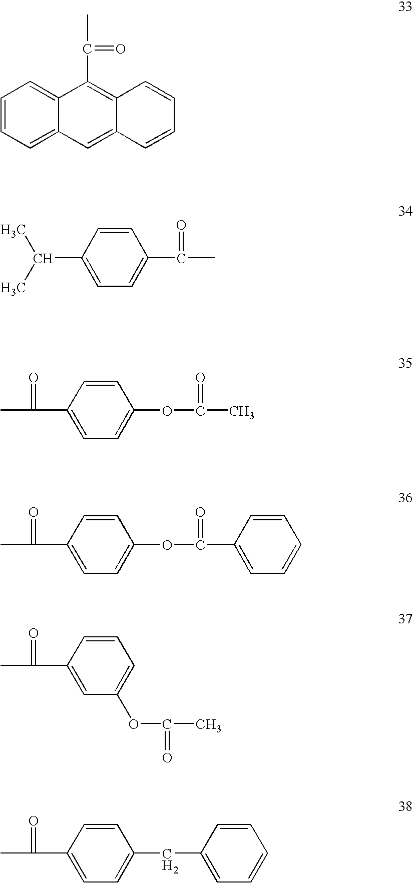

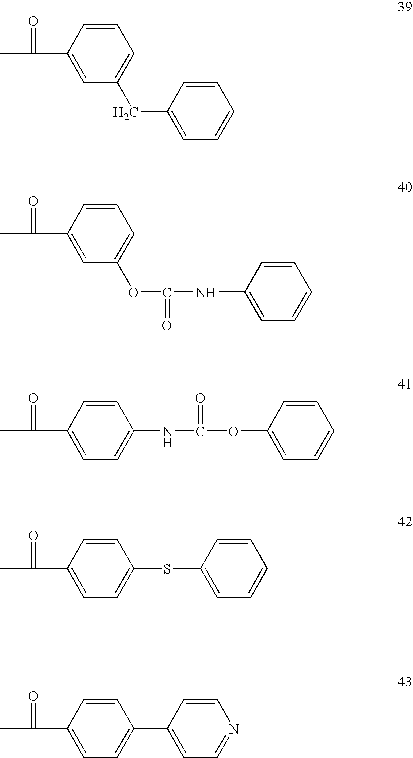

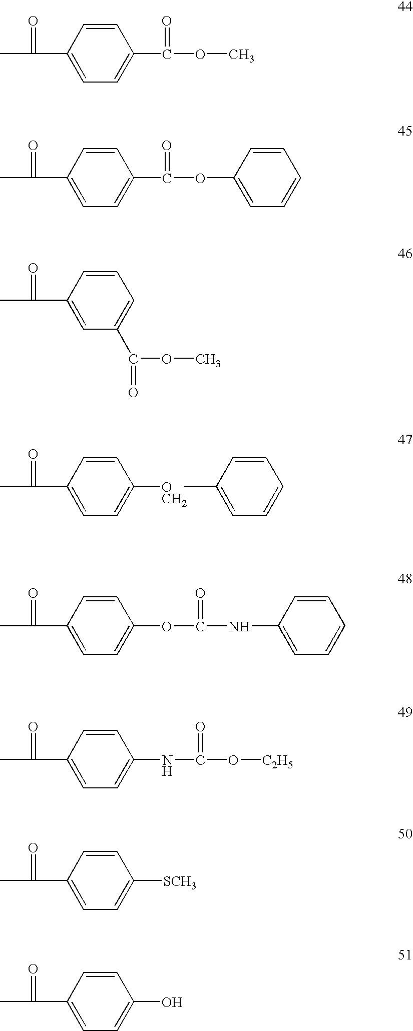

The cellulose acylate of the invention has a weight average polymerization degree of preferably from 250 to 800, more preferably from 300 to 600. The cellulose acylate has a number average molecular weight of preferably from 70000 to 230000, more preferably from 75000 to 230000, most preferably from 78000 to 120000.

A weight average molecular weight (Mw)/number average molecular weight (Mn) ratio (Mw/Mn) is preferably 2.0 or greater but not greater than 4.0, more preferably 2.0 or greater but not greater than 3.5.

### (Additives)

### (Plasticizer)

In order to improve mechanical physical properties or improving a drying speed, a plasticizer can be added to the cellulose acylate film of the invention. As the plasticizer, phosphate esters and carboxylate esters are used. Examples of the phosphate esters include triphenyl phosphate (TPP) and tricresyl phosphate (TCP). Phthalate esters and citrate esters are representative of the carboxylate esters. Examples of the phthalate esters include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citrate esters include triethyl o-acetylcitrate (OACTE) and tributyl o-acetylcitrate (OACTB). Examples of other carboxylates include butyl oleate, methylacetyl licinolate, dibutyl sebacate, and various trimellitate esters. Of these, phthalate ester plasticizers (such as DMP, DEP, DBP, DOP, DPP, and DEHP) are preferred, with DEP and DPP being especially preferred.

The amount of the plasticizer is preferably from 0.1 to 25 parts by mass, more preferably from 1 to 20 parts by mass, most preferably from 3 to 15 parts by mass based on 100 parts by mass of the cellulose acetate. (In this specification, mass ratio is equal to weight ratio.)

### (Ultraviolet Absorber)

The cellulose acylate film of the invention preferably contains an ultraviolet absorber.

The amount of the ultraviolet absorber is preferably from 1 part by mass to 30 parts by mass, more preferably from 2 parts by mass to 15 parts by mass, most preferably from 3 parts by mass to 10 parts by mass, each based on 100 parts by mass of the cellulose acylate.

Examples of the ultraviolet absorber include oxybenzophenone compounds, benzotriazole compounds, salicylate ester compounds, benzophenone compounds, cyano acrylate compounds, and nickel complex salt compounds. Of these, benzotriazole compounds which stain less are preferred. Ultraviolet absorbers as described in JP-A-10-182621 and JP-A-8-337574 and high molecular ultraviolet absorbers as described in JP-A-6-148430 are also preferred. When the cellulose acylate film of the invention is used as a protective film of a polarizing plate, ultraviolet absorbers excellent in an absorption ability of ultraviolet rays having a wavelength not greater than 370 nm are preferred from the viewpoint of preventing deterioration of a polarizer or a liquid crystal and those having less absorption of a visible light having a wavelength of 400 nm or greater are preferred from the viewpoint of liquid crystal display properties. Ultraviolet absorbers having an absorption maximum within a wavelength range of 250 nm or greater but not greater than 380 nm are especially preferred.

Specific examples of the benzotriazole ultraviolet absorbers useful in the invention include, but not limited to, 2-(2′-hydroxy-5′-methylphenyl)benzotriazole, 2-(2′-hydroxy-3′,5′-di-t-butylphenyl)benzotriazole, 2-(2′-hydroxy-3′,5′-methylphenyl)benzotriazole, 2-(2′-hydroxy-3′,5′-di-t-butylphenyl)-5-chlorobenzotriazole, 2-[2′-hydroxy-3′-(3″,4″,5″,6″-tetrahydrophthalimidomethyl)-5′-methylphenyl]benzotriazole, 2,2-methylenebis[4-(1,1,3,3-tetramethylbutyl)-6-(2H-benzotriazol-2-yl)phenol], 2-(2′-hydroxy-3′-t-butyl-5′-methylphenyl)-5-chlorobenzotriazole, 2-(2H-benzotriazol-2-yl)-6-(linear or side chain dodecyl)-4-methylphenol, and a mixture of octyl-3-[3-t-butyl-4-hydroxy-5-(chloro-2H-benzotriazol-2-yl)phenyl]propionate and 2-ethylhexyl-3-[3-t-butyl-4-hydroxy-5-(5-chloro-2H-benzotriazol-2-yl)phenyl]propionate.

Also, commercially available products such as “TINUVIN 109”, “TINUVIN 171”, “TINUVIN 326”, and “TINUVIN 328” (each, trade name; product of Ciba Specialty Chemicals) can be preferably used.

As the ultraviolet absorber, an ultraviolet absorber having a melting point of 25° C. or less or a mixture of two or more ultraviolet absorbers containing the ultraviolet absorber having a melting point of 25° C. or less is preferred. When two or more ultraviolet absorbers are contained, the percentage of the ultraviolet absorber(s) having a melting point of 25° C. or less is preferably 80 mass % or greater but not greater than 100 mass % relative to the total amount of the ultraviolet absorbers (when the total amount is set at 100 mass %). The percentage is more preferably 90 mass % or greater but not greater than 100 mass %, most preferably 95 mass % or greater but not greater than 100 mass %. In short, use of the ultraviolet absorber mixture containing the ultraviolet absorber(s) having a melting point of 25° C. or less within the above-described range is preferred. When at least one such ultraviolet absorber is contained in an amount within the above-described range, an increase in haze upon stretching operation can be reduced further, and moreover reverse dispersion characteristics of retardation can be enhanced without causing a large change in the transmittance properties of the film in the ultraviolet region.

Examples of the ultraviolet absorber having a melting point of 25° C. or less include “TINUVIN 109” and “TINUVIN 171”.

### (Other Additives)

A degradation preventive (for example, antioxidant, peroxide decomposing agent, radical inhibitor, metal inactivator, acid scavenger, and amine) may be added to the cellulose acylate film. The degradation preventive is described in JP-A-3-199201, JP-A-5-1907073, JP-A-5-194789, JP-A-5-271471, and JP-A-6-107854. From the viewpoints of bringing about sufficient effects and preventing bleed out of the degradation preventive agent onto the film surface, the amount of the degradation preventive is preferably from 0.01 to 1 mass %, more preferably from 0.01 to 0.2 mass % of a solution (dope) to be prepared. Especially preferred examples of the degradation preventive include butylated hydroxytoluene (BHT) and tribenzylamine (TBA).

### (Fine Particles as Matting Agent)

Fine particles are preferably added to the cellulose acylate film of the invention as a matting agent. Examples of the fine particles usable in the invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate, and calcium phosphate. Of these, silicon-containing fine particles are preferred because they decrease the turbidity. Silicon dioxide is especially preferred. The fine particles of silicon dioxide have preferably an average primary particle size of from 1 nm to 20 nm and an apparent specific gravity of 70 g/liter or greater. The average primary particle size from 5 nm to 16 nm is more preferred because it can reduce the haze of the film. The apparent specific gravity is preferably from 90 to 200 g/liter, more preferably from 100 to 200 g/liter. As the apparent specific gravity is greater, a dispersion having a higher concentration can be prepared. This brings about improvement in haze and suppression of aggregation.

Such fine particles usually form secondary particles having an average particle size of from 0.05 to 2.0 μm. These fine particles are present as an aggregate of first particles in the film, thereby forming irregularities of from 0.05 to 2.0 μm on the film surface. The average secondary particle size is preferably from 0.05 pm to 1.0 μm, more preferably from 0.1 μm to 0.7 μm, most preferably from 0.1 μm to 0.4 μm. With respect to the primary or secondary particle size, particles in the film are observed by a scanning electron microscope, and a diameter of the circumcircle of each particle is defined as the particle size. An average of the particle sizes of 200 particles observed at varied positions is defined as the average particle size.

As the fine particles of silicon dioxide, commercially available products such as “AEROSIL R972”, “AEROSIL R972V”, “AEROSIL R974”, “AEROSIL R812”, “AEROSIL 200”, “AEROSIL 200V”, “AEROSIL 300”, “AEROSIL R202”, “AEROSIL OX50”, and “AEROSIL TT600” (each, trade name; product of Nippon Aerosil) can be used. Fine particle of zirconium oxide are commercially available as “AEROSIL R976” and “AEROSIL R811” (each, trade name; product of Nippon Aerosil) and they can be used.

Of these, “AEROSIL 200V” and “AEROSIL R972V” are especially preferred because they are fine particles of silicon dioxide have an average primary particle size not greater than 20 nm and an apparent specific gravity of 70 g/liter or greater and have an effect of decreasing a friction coefficient while keeping the haze of an optical film at a low level.

The matting agent to be used in the invention is preferably prepared as follows. A fine particle dispersion is prepared in advance by mixing the solvent and fine particles under stirring. The fine particle dispersion is then added to a separately prepared first additive solution having a cellulose acylate concentration less than 5 mass % and having a molecular weight of from 200 to 2000, followed by stirring to dissolve the former in the latter. After the addition of a second additive solution to the resulting solution under stirring, the solution thus obtained is mixed with a main cellulose acylate dope solution.

The matting agent has a hydrophobized surface so that when hydrophobic additives are added, they are adsorbed to the surface of the matting agent and with this as a nucleus, an aggregate of the additives tend to appear. It is therefore preferred to mix, after mixing of relatively hydrophilic additives with the dispersion of a matting agent, the resulting mixture with hydrophobic additives, because aggregation of the additives on the surface of the matting agent can be suppressed, haze can be suppressed to a low level and light leakage in black display state when the film is incorporated in a liquid crystal display device can be reduced.

For mixing of the matting agent dispersion and the additive solution and subsequent mixing with the cellulose acylate solution, use of an in-line mixer is preferred. The invention is not limited to such a method. When fine particles of silicon dioxide are added and dissolved in a solvent or the like, the concentration of silicon dioxide is preferably from 5 to 30 mass %, more preferably from 10 to 25 mass %, most preferably from 15 to 20 mass %. The higher dispersion concentration is preferred because the turbidity occurring by the same amount of addition is lower and the haze and aggregation degree are improved. The amount of the matting agent in the final cellulose acylate dope solution is preferably from 0.001 to 1.0 mass %, more preferably from 0.005 to 0.5 mass %, most preferably from 0.01 to 0.1 mass %.

### [Preparation of Cellulose Acylate Film]

The cellulose acylate film of the invention is prepared preferably by a solvent casting method. In the solvent casting method, the film is prepared using a solution (dope) having a cellulose acylate dissolved in an organic solvent.

The organic solvent preferably includes a solvent selected from C₃₋₁₂ ethers, C₃₋₁₂ ketones, C₃₋₁₂ esters, and C₁₋₆ halogenated hydrocarbons.

The ethers, ketones and esters may each have a cyclic structure. Compounds containing any two or more of the functional groups of the ether, ketone and the ester (that is, —O—, —CO—, and —COO—) can also be used as the organic solvent. The organic solvent may contain another functional group such as an alcoholic hydroxyl group. In the organic solvent having two or more functional groups, the number of carbon atoms thereof falls within the above-described preferred range of the number of carbon atoms of the solvent containing any one of the functional groups.

Examples of the C₃₋₁₂ ethers include diisopropyl ether, dimethoxymethane, dimethoxyethane, 1,4-dioxane, 1,3-ioxolan, tetrahydrofuran, anisole, and phenetole.

Examples of the C₃₋₁₂ ketones include acetone, methyl ethyl ketone, diethyl ketone, diisobutyl ketone, cyclohexanone, and methylcyclohexanone.

Examples of the C₃₋₁₂ esters include ethyl formate, propyl formate, pentyl formate, methyl acetate, ethyl acetate, and pentyl acetate.

Examples of the organic solvent containing two or more functional groups include 2-thoxyethyl acetate, 2-methoxyethanol, and 2-butoxyethanol.

The number of carbon atoms of the halogenated hydrocarbon is preferably 1 or 2, most preferably 1. The halogen of the halogenated hydrocarbon is preferably chlorine. A proportion of the halogen substituted for the hydrogen atom of the halogenated hydrocarbon is preferably from 25 to 75 mole %, more preferably from 30 to 70 mole %, still more preferably from 35 to 65 mole %, most preferably from 40 to 60 mole %. Methylene chloride is a representative halogenated hydrocarbon.

As the organic solvent of the invention, a mixture of methylene chloride with an alcohol is preferred. The alcohol is added in an amount of preferably 1 mass % or greater but not greater than 50 mass %, more preferably 10 mass % or greater but not greater than 40 mass %, most preferably 12 mass % or greater but not greater than 30 mass %, each relative to methylene chloride. As the alcohol, methanol, ethanol, and n-butanol are preferred, and a mixture of two or more alcohols may be used.

The cellulose acylate solution can be prepared by an ordinarily employed method including treatment at a temperature of 0° C. or greater (normal temperature or high temperature). The solution can be prepared using a preparation process of a dope and a device in the usual solvent casting method. In the ordinarily employed method, use of a halogenated hydrocarbon (especially, methylene chloride) as the organic solvent is preferred.

The amount of the cellulose acylate is adjusted so that that it is contained in an amount of from 10 to 40 mass % based on the total amount of the resulting solution. The amount of the cellulose acylate is more preferably from 10 to 30 mass %. Any additive selected from the above-descried additives may be added to the organic solvent (prime solvent).

The cellulose acylate solution can be prepared by stirring the cellulose acylate and the organic solvent at normal temperature (from 0 to 40° C.). The solution with a high concentration may be stirred under pressure and heat. More specifically, the cellulose acylate and organic solvent are charged in a pressure vessel, and after hermetic sealing of the vessel, the mixture is stirred under pressure while heating at a temperature range of from the boiling point of the solvent at normal temperature to a temperature at which the solvent is not boiled.

The heating temperature is usually 40° C. or greater, preferably from 60 to 200° C., more preferably from 80 to 110° C.

The components may be charged in a vessel after mixed roughly. Alternatively, they may be successively charged in the vessel. The vessel must be constructed such that stirring can be performed therein. Pressure is applied to the vessel by injecting thereinto an inert gas such as a nitrogen gas. An increase in the vapor pressure of the solvent by heating may be utilized. Alternatively, after hermetic sealing of the vessel, the components may be added under a pressure.

The vessel is heated preferably from the outside thereof. For example, a jacket type heater may be employed. Alternatively, the whole vessel may be heated by providing a plate heater outside the vessel and circulating a liquid through a tube arranged thereover.

Stirring is performed preferably using a stirring blade installed inside the vessel. The stirring blade is preferably long enough to reach the vicinity of the wall of the vessel. At the end of the stirring blade, a scraping blade is preferably installed in order to accelerate constant regeneration of a liquid film on the wall of the vessel.

The vessel may be equipped with a measuring instrument such as pressure gauge and thermometer. The components are dissolved in the solvent within the vessel. A dope solution may be cooled and then taken out from the vessel, or may be taken out from the vessel and then cooled by using a heat exchanger or the like.

The solution can also be prepared by a cooling and dissolving method. According to the cooling and dissolving method, the cellulose acylate can be dissolved in an organic solvent which hardly dissolves it therein by the ordinary method. When the cooling and dissolved method is employed for a solvent capable of dissolving the cellulose acylate therein by the ordinary dissolving method, it enables rapid preparation of a uniform solution.

In the cooling and dissolving method, first of all, the cellulose acylate is added in portions in an organic solvent at room temperature while stirring. The amount of the cellulose acylate is preferably adjusted so that the cellulose acylate content in the mixture is from 10 to 40 mass %. The cellulose acylate content is more preferably from 10 to 30 mass %. Any of the above-described additives may be added to the mixture in advance.

Next, the mixture is cooled to from −100 to −10° C. (preferably from −80 to −10° C., more preferably from −50 to −20° C., most preferably from −50 to −30° C.). The cooling can be carried out, for example, in a dry ice-methanol bath (−75° C.) or a cooled diethylene glycol solution (from −30 to −20° C.). The mixture of the cellulose acylate and the organic solvent is solidified by cooling.

The cooling rate is preferably 4° C./min or greater, more preferably 8° C./min or greater, most preferably 12° C./min or greater. The greater the cooling rate, the better. A theoretical upper limit is, however, 10000° C./sec; a technical upper limit is 1000° C./sec; and a practical upper limit is 100° C./sec. The term “cooling rate” as used herein means a value obtained by dividing a difference between the temperature at the starting time of cooling and the final cooling temperature by a time required for reaching the final cooling temperature after cooling is started.

After cooling, the resulting solid is heated to from 0 to 200° C. (preferably from 0 to 150° C., more preferably from 0 to 120° C., most preferably from 0 to 50° C.), whereby the cellulose acylate is dissolved in the organic solvent. The temperature may be elevated only by allowing the solid to stand at room temperature. The solid may be heated in a warm bath.

The heating rate is preferably 4° C./min or greater, more preferably 8° C./min or greater, most preferably 12° C./min or greater. The greater the heating rate, the better. A theoretical upper limit is however 10000° C./sec; a technical upper limit is 1000° C./sec; and a practical upper limit is 100° C./sec. The heating rate is a value obtained by dividing a difference between the temperature at the starting time of heating and the final heating temperature by a time required for reaching the final heating temperature after heating is started.

In the above-described manner, a uniform solution is obtained. If the solution is not sufficiently uniform, the cooling and heating operation may be repeated. Whether the solution is sufficiently uniform or not can be judged only by visually observing the appearance of the solution.

In the cooling and dissolving method, in order to avoid mixing, in the solution, of water due to dew condensation at the time of cooling, use of a closed vessel is preferred. In the cooling and heating operation, dissolution time can be reduced when pressure is applied upon cooling and pressure is reduced upon heating. In carrying out the pressure application or pressure reduction, use of a pressure vessel is preferred.

According to the measurement by a differential scanning calorimeter (DSC), a pseudo phase transition point between a sol state and a gel state is present in the vicinity of 33° C. in a 20 mass % solution obtained by dissolving a cellulose acetate (degree of acetylation: 60.9%, viscosity average polymerization degree: 299) in methyl acetate by the cooling and dissolving method, and the solution becomes in a uniform gel state at a temperature not greater than this temperature. Accordingly, this solution must be kept at the pseudo phase transition point or greater, preferably at a temperature greater by about 10° C. than the gel phase transition point. However, the pseudo phase transition point varies depending on the degree of acetylation, viscosity average polymerization degree or solution concentration of cellulose acetate, or the organic solvent.

A cellulose acylate film is prepared using the cellulose acylate solution (dope) by the solvent casting method. A retardation raising agent is preferably added to the dope.

The film is formed by casting the dope on a drum or band, and then vaporizing the solvent. The dope before casting is preferably adjusted so that its solid content becomes from 18 to 35 mass %. The drum or band is preferably finished to have a mirror surface. The dope is preferably cast on a drum or band having a surface temperature not higher than 10° C.

A drying method in the solvent casting method is described in U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430, and JP-A-62-115035. Drying on the band or drum can be carried out by blowing air or an inert gas such as nitrogen.

The drying of the cellulose acylate film of the invention on the band or drum is carried out preferably at a temperature as low as possible. When the residual solvent content is 30 mass % or greater, the drying temperature is preferably 150° C. or less, more preferably 120° C. or less, most preferably 90° C. or less.

Drying within the above-described temperature range can reduce the generation of fine crystals in the film.

The film can also be formed by casting the cellulose acylate solution (dope) into two or more layers. In this case, the cellulose acylate film is preferably prepared by the solvent casting method. The film is formed by casting the dope on a drum or bad, and vaporizing the solvent. The concentration of the dope before casting is preferably adjusted so that its solid content falls within a range of from 10 to 40 mass %. The drum or band is preferably finished to have a mirror surface.

The cellulose acylate film of the invention is preferably obtained by stretching in a traveling direction (longitudinal direction) of the film and/or a direction (width direction) perpendicular thereto.

A method for stretching in the width direction is described in, for example, JP-A-62-115035, JP-A-4-152125, JP-A-4-284211, JP-A-4-298310, and JP-A-1148271. The film can be stretched in a longitudinal direction, for example, by adjusting the rate of conveyor rollers of the film to make a take-up rate faster than a strip-off rate. On the other hand, the film can be stretched in a width direction by conveying the film while keeping its width by a tenter and gradually increasing the width of the tenter. The film may be stretched by using a stretching machine after drying of the film (preferably by uniaxial stretching using a long stretching machine).

In order to improve the development of both Re and Rth, stretching both in a traveling direction and a width direction is especially preferred.

For the formation of the cellulose acylate film of the invention, stretching is performed preferably at a predetermined stretching rate while keeping a residual solvent content not greater than a predetermined amount. When the stretching is started, the residual solvent content is usually 1 mass % or greater but not greater than 80 mass %, preferably 1 mass % or greater but not greater than 70 mass %, more preferably 1 mass % or greater but not greater than 60 mass %.

The stretching temperature is preferably (the glass transition point of the film−20° C.) or greater but not greater than (the glass transition point of the film+20° C.).

A stretch ratio of the film is preferably from 1% to 100%, more preferably from 5% to 90%. The term “stretch ratio of the film” as used herein means a value determined by the following equation (12):

{(Dimension after stretching/dimension before stretching)−1}×100(%) (12)

A (stretch ratio in the width direction/stretch ratio in the longitudinal direction) ratio is preferably 1 or greater but not greater than 10, more preferably 2 or greater but not greater than 8.

In short, the cellulose acylate film of the invention is preferably obtained by stretching a film, which has been formed using a cellulose acylate having an acylation degree of 2.50 or greater but not greater than 2.90, in a traveling direction of the film and/or a direction perpendicular thereto at a stretch ratio of 1% or greater but not greater than 100%, more preferably 5% or greater but not greater than 90%.

### [Properties of the Cellulose Acylate Film]

### (Film Thickness)

The cellulose acylate film of the invention has a thickness of 30 μm or greater but less than 70 μm, preferably 40 μm or greater but not greater than 60 μm, more preferably 40 μm or greater but not greater than 55 μm.

By setting the film thickness within the above-described range, a cellulose acylate film having a high orientation degree and excellent in handling properties can be obtained. More specifically, when the film thickness is less than 30 μm, the transport at the time of manufacturing a long roll becomes unstable and troubles such as cracks or flaws occur. When the film thickness exceeds 70 μm, the degree of orientation cannot be improved sufficiently.

### (Retardation of the Film)

In the present specification, Re and Rth represent an in-plane retardation and a retardation in a thickness direction. The Re is measured by making light having a wavelength of 590 nm incident in a normal line direction in “KOBRA 21ADH” (trade name; product of Oji Science Instruments). The Rth is calculated by “KOBRA21 ADH” on the basis of retardation values as measured in three directions in total, that is, the above-described Re, a retardation value as measured by making light having a wavelength of 590 nm incident from a direction inclined by +40° against the normal line direction of the film while making the in-plane slow axis (judged by “KOBRA 21ADH”) serve as a tilt axis (rotation axis), and a retardation value as measured by making light having a wavelength of 590 nm incident from a direction inclined by −40° against the normal line direction of the film while making the in-plane slow axis serve as a tilt axis (rotation axis). Here, as hypothetical values of an average refractive index, values described in Polymer Handbook (John Wiley & Sons, Inc.) and various catalogues of optical films can be employed. When an average refractive index is not known, it can be measured by an Abbe's refractometer. The average refractive index of each of major optical films is as follows:

Cellulose acylate (1.48),

cycloolefin polymer (1.52),

polycarbonate (1.59),

polymethyl methacrylate (1.49), and

polystyrene (1.59).

By inputting a hypothetical value of the average refractive index and a film thickness, KOBRA 21 ADH computes nx, ny and nz.

In the invention, when the retardation shows “reverse dispersion” in wavelength dispersion, it means that the shorter the wavelength, the smaller the retardation value.

The retardation of the cellulose acylate film of the invention satisfies the following relations of the equations (1) to (6):

20 nm<Re(548)<100 nm (1)

100 nm<Rth(548)<400 nm (2)

0.5≦Re(446)/Re(548)≦0.90 (3)

1.05≦Re(629)/Re(548)≦1.50 (4)

0.5≦Rth(446)/Rth(548)≦0.95 (5)

1.05≦Rth(629)/Rth(548)≦1.50 (6)

The equation (1) is more preferably the following equation (1-b), most preferably the following equation (1-c):

30 nm<Re(548)<90 nm (1-b)

35 nm<Re(548)<80 nm (1-c)

The equation (2) is more preferably the following equation (2-b), most preferably the following equation (2-c):

110 nm<Rth(548)<350 nm (2-b)

120 nm<Rth(548)<300 nm (2-c)

The equation (3) is more preferably the following equation (3-b), most preferably the following equation (3-c):

0.6≦Re(446)/Re(548)≦0.87 (3-b)

0.7≦Re(446)/Re(548)≦0.85 (3-c)

The equation (4) is more preferably the following equation (4-b), most preferably the following equation (4-c):

1.07≦Re(629)/Re(548)≦1.30 (4-b)

1.10≦Re(629)/Re(548)≦1.20 (4-c)

The equation (5) is more preferably the following equation (5-b), most preferably the following equation (5-c):

0.6≦Rth(446)/Rth(548)≦0.90 (5-b)

0.7≦Rth(446)/Rth(548)≦0.85 (5-c)

The equation (6) is more preferably the following equation (6-b), most preferably the following equation (6-c):

1.07≦Rth(629)/Rth(548)≦1.40 (6-b)

1.10≧Rth(629)/Rth(548)≦1.30 (6-c)

By controlling the retardation to fall within the above-described range, a liquid crystal display device having a less color shift at any viewing angle can be obtained when the film is incorporated as an optically compensatory sheet member in the device. Moreover, by adjusting the thickness of the film to fall within the above-described range and controlling the retardation as described above, it is possible to constitute the film by using only reusable materials, reduce the haze and improve the wavelength dispersion characteristics.

Described specifically, a contrast change due to viewing angle becomes large when the Re(548) is 20 nm or less or 100 nm or greater.

The contrast change due to viewing angle also becomes large when the Rth(548) is 100 nm or less or 400 nm or greater.

A color shift depending on a viewing angle becomes large when the Re(446)/Re(548), Re(629)/Re(548), Rth(446)/Rth(548) or Rth(629)/Rth(548) is outside the above-described range.

A film satisfying the above-described equations (1) to (6) can be obtained by selecting a proper cellulose acylate material, adjusting the kind or amount of additives such as ultraviolet absorber or controlling the stretching conditions. Details will be described later in Examples.

### (Haze)

The haze of the cellulose acylate film of the invention is preferably 0.1 or greater but not greater than 0.8, more preferably 0.1 or greater but not greater than 0.7, most preferably 0.1 or greater but not greater than 0.60. The haze can be measured using any haze meter ordinarily used in the related field. For example, a haze meter (“1001DP”, product of Nippon Denshoku Industries) can be used for its measurement. In the invention, the haze measured using a haze meter (“HGM-2DP”, trade name; product of Suga Test Instruments) according to JIS K6714 was used. By controlling the haze within the above-described range, the resulting film can provide a high contrast image when it is incorporated as an optically compensatory sheet in a liquid crystal display device.

### (Transmission of Film)

The cellulose acylate film of the invention has preferably light transmission at 370 nm of 5% or less, more preferably 0% or greater but not greater than 2%. It has preferably light transmission at 390 nm of 80% or greater, more preferably 85% or greater.

By controlling the light transmission within the above-described range, the durability of liquid crystal cells can be improved without staining the film.

The transmission of the film can be measured, for example, by a spectrophotometer “UV 3500” (trade name; product of Shimadzu Corporation).

### (Orientation Degree of Main Cellulose Acylate Chain)

It is preferred that assuming that the degree of in-plane orientation of a cellulose acylate molecular chain of the entire film thickness is Po and the degree of orientation of the cellulose acylate molecular chain in a thickness direction of the film is Pth, the Po and Pth satisfy the following relations of equations (7) and (8):

0.040≦Po≦0.10 (7)

0.12≦Pth≦0.40 (8)

The equation (7) is preferably the following equation (7-b), most preferably the following equation (7-c):

0.05≦Po≦0.10 (7-b)

0.06≦Po≦0.10 (7-c)

The equation (8) is preferably the following equation (8-b), most preferably the following equation (8-c):

0.15≦Pth≦0.35 (8-b)

0.20≦Pth≦0.30 (8-c)

When the Po is the above-described lowest limit or greater, the Re becomes a desired value. When the Po is the above-described upper limit or less, on the other hand, the haze can be suppressed sufficiently. The Po within the above-described range is therefore preferred.

When the Ph is the above-described lowest limit or greater, the Rth becomes a desire value. When the Pth is the above-described upper limit or less, on the other hand, the haze can be suppressed sufficiently. The Pth within the above-described range is therefore preferred.

In the cellulose acylate film of the invention, the degree Po of in-plane orientation of the cellulose acylate molecular chain of the film surface and the degree Po of in-plane orientation of the cellulose acylate molecular chain of the entire film thickness preferably satisfy the relation of the following equation (9):

1≦(Po of the film surface)/(Po of the entire film thickness)≦1.5 (9)

The equation (9) is more preferably the following equation (9-b), most preferably the following equation (9-c):

1≦(Po of the film surface)/(Po of the entire film thickness)≦1.3 (9-b)

1≦(Po of the film surface)/(Po of the entire film thickness)≦1.2 (9-c)

By controlling the degree of orientation of the cellulose acylate molecular chain within the above-described range, a cellulose acylate film exhibiting large reverse wavelength dispersion characteristics and having large Re and Rth is available.

The degree of in-plane orientation (orientation order parameter) Po of the film surface in the invention can be determined from peak intensities of 2θχ/Φ=6˜11°, which have been detected by the rotation of an X-ray detector and sample at angles of 2θχ and Φ by using thin-film X-ray In-Plain method, according to the following expression (21):

P₀=(3 cos²β−1)/2 (21)

wherein, cos²β can be determined in accordance with the following equation:

$${cos}^{2} β = {\int }_{0}^{π} {cos}^{2} β \cdot I ( β ) \cdot sin β d β / {\int }_{0}^{π} I ( β ) \cdot sin β d β$$

The degree Po of in-plane orientation of the cellulose acylate molecular chain of the entire film thickness can be determined according to the above-described expression by using an average of peak intensities of 2θ˜6˜11° in two-dimensional transmission X-ray measurement.

The degree Pth of orientation of the film in a thickness direction is determined as an average value of the surface orientation of the cross-section of the film including the traveling direction and thickness direction and the surface orientation of the cross-section of the film including the width direction and thickness direction.

### (Planar Troubles)

In the cellulose acylate film of the invention, the number of foreign matters or aggregates of 30 μm or greater present on a 30-cm wide and 1-m long portion at both ends of the cellulose acylate film used as a sample is preferably from 0 to 50, more preferably from 0 to 40, especially preferably from 0 to 30.

### (Surface Treatment of Cellulose Acylate Film)

The cellulose acylate film has preferably a surface energy of from 55 to 75 mN/m. The film is preferably subjected to surface treatment in order to adjust the surface energy within the above-described range. Examples of the surface treatment include saponification treatment, plasma treatment, flame treatment and ultraviolet irradiation treatment. The saponification treatment includes acid saponification treatment and alkali saponification treatment, while the plasma treatment includes corona discharge treatment and glow discharge treatment. In order to keep surface flatness of the film, the temperature of the cellulose acylate film is preferably adjusted to the glass transition point (Tg) or less, more specifically, 150° C. or less in such a surface treatment. The surface energy of the cellulose acetate film after the surface treatment is preferably from 55 to 75 mN/m.

The glow discharge treatment may be treatment with low temperature plasma which occurs under a low pressure gas of from 10⁻³ to 20 Torr, and plasma treatment under atmospheric pressure is also preferred. A plasma excited gas is a gas plasma-excited under the above-described conditions. Examples of it include argon, helium, neon, krypton, xenon, nitrogen, carbon dioxide and chlorofluorocarbons such as tetrafluoromethane, and mixtures thereof. Detailed description on them is found in the Technical Report of Japan Institute of Invention and Innovation (Technology No. 2001-1745, published on Mar. 15, 2001 by Japan Institute of Invention and Innovation), pp. 30-32. For plasma treatment under atmospheric pressure, which has recently attracted attentions, irradiation energy of from 20 to 500 kGy is used under from 10 to 1000 keV and more preferably, irradiation energy of from 20 to 300 kGy is used under from 30 to 500 keV. Of these, alkali saponification treatment is especially preferred and it is very effective as the surface treatment of a cellulose acylate film.

Alkali saponification treatment is preferably performed either by dipping the cellulose acylate film directly in a saponification solution tank or by applying the saponification solution to the cellulose acylate film. Examples of the application method include dip coating, curtain coating, extrusion coating, bar coating and E-type coating. As a solvent for the coating solution to be used for the alkali saponification treatment, that having a good wetting property to facilitate application of the coating solution to a transparent support and capable of keeping a good surface state while avoiding formation of irregularities on the surface of the transparent support even if the solvent of the saponification solution is used is preferably selected. Specifically, alcoholic solvents are preferred, with isopropyl alcohol, being especially preferred. An aqueous solution of a surfactant can also be used as the solvent. The alkali to be used in the coating solution for alkali treatment is preferably an alkali which dissolves in the above-described solvent, with KOH and NaOH being preferred. The pH of the coating solution for saponification treatment is preferably 10 or greater, more preferably 12 or greater. The reaction time for the alkali saponification is preferably from 1 second to 5 minutes, more preferably from 5 seconds to 5 minutes, particularly preferably from 20 seconds to 3 minutes, at room temperature. After completion of the alkali saponification reaction, the saponification solution-applied surface is preferably washed with water or successively with an acid and water.

The surface energy of the solid thus obtained can be determined by the contact angle method, the wet heating method or the adsorption method as described in The Basic Theory and Application of Wetting”, published by Realize Co., Ltd. on Dec. 10, 1989]. The contact angle method is suited for use in the cellulose acylate film of the invention. Described specifically, the surface energy of the film can be determined by adding, dropwise to the film, two solutions whose surface energies are known, defining an angle which is formed between the film surface and a tangent to the liquid drop at the intersection therebetween and is on the side of the liquid drop as the contact angle, and carrying out calculation.

A cellulose acylate film having a surface energy of from 55 to 75 mN/m can be obtained by carrying out the above described surface treatment. Use of this cellulose acylate film as a transparent protective film of a polarizing plate can improve the adhesion between a polarization film and the cellulose acylate film.

When the cellulose acylate film of the invention is used in an OCB mode liquid crystal display device, it is incorporated therein as the optically compensatory sheet of the invention obtained by forming an orientation film on the cellulose acylate film and then laying thereover an optically anisotropic layer containing a discotic compound or rod-like liquid crystal compound. The optically anisotropic layer is formed by orienting the discotic compound (or a rod-like liquid crystal compound) on the orientation film and fixing the orientation state thus formed. When the optically anisotropic layer is laid over the cellulose acylate film, it is conventionally necessary to form a gelatin undercoat layer between the cellulose acylate film and the orientation film to secure the adhesion therebetween. Use of the cellulose acylate film having a surface energy of 55 to 75 mN/m, as in the invention, enables the omission of the gelatin undercoat layer.

### [Optical Material Using Cellulose Acylate Film]

### (Optically Compensatory Sheet)

The optically compensatory sheet of the invention will next be described.

The optically compensatory sheet of the invention is characterized in that it contains the above-described cellulose acylate film of the invention. The cellulose acylate film of the invention functions as an optically compensatory sheet even if it is used singly. It is therefore preferred to use the cellulose acylate film of the invention as an optically compensatory sheet. The optically compensatory sheet of the invention may have an optically anisotropic layer thereon.

The optically anisotropic layer preferably contains a liquid crystal compound. In the invention, the optically anisotropic layer containing a discotic compound (discotic liquid crystal) as the liquid crystal compound is especially preferred. The discotic compound has side chains extending radially from the discotic core portion thereof and thus has a similar structure to that of a triphenylene derivative. In order to impart time-dependent stability to the compound, a group which reacts by heat or light is preferably introduced therein. Preferred examples of the discotic compound are described in JP-A-8-50206.

The following is one example of the discotic compound.

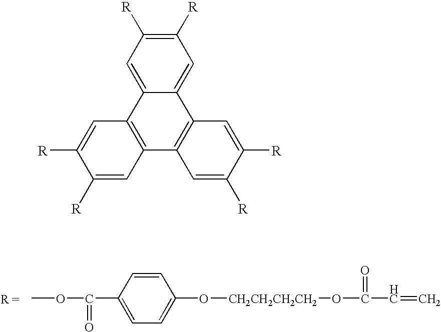

The discotic liquid crystal molecule has a pre-tilt angle in a rubbing direction in the vicinity of the oriented layer and is oriented substantially parallel to the film plane. On the opposite side, that is, the air surface side, the discotic liquid crystal molecule stands up and is oriented in a substantially vertical form against the plane. The discotic liquid crystal layer, as a whole, takes hybrid orientation, and viewing angle enlargement of TFT-LCD of a TN mode can be realized by this layer structure.

The optically anisotropic layer is usually available by dissolving a discotic compound and other compounds (for example, a polymerizable monomer and a photopolymerization initiator) in a solvent, applying the resulting solution onto the oriented layer, drying, heating to the discotic nematic phase forming temperature, polymerizing by exposure to UV light or the like, and then cooling. The transition temperature of the discotic compound, which is to be used in the invention, from discotic nematic liquid crystal phase to solid phase is preferably from 70 to 300° C., especially preferably from 70 to 170° C.

As compounds other than discotic compounds to be added to the optically anisotropic layer, any compound can be used insofar as it has compatibility with the discotic compound and can give a preferred change of the tilt angle to the discotic compound or it does not hinder the orientation. Examples of such a compound include polymerizable monomers (such as compounds having a vinyl group, vinyloxy group, acryloyl group, or methacryloyl group), orientation controlling additives on the air interface side such as fluorine-containing triazine compounds, and polymers such as cellulose acetate, cellulose acetate propionate, hydroxypropyl cellulose, and cellulose acetate butyrate. The compound is usually added in an amount of from 0.1 to 50 mass %, preferably from 0.1 to 30 mass %, relative to the discotic compound.

The optically anisotropic layer has a thickness of preferably from 0.1 to 10 μm, more preferably from 0.5 to 5 μm.

### (Polarizing Plate)

The polarizing plate of the invention is characterized in that it has a polarization film and two transparent protective films disposed on both sides thereof and at least one of the transparent protective films is the above-described optically compensatory sheet of the invention.

The polarizing plate is usually composed of a polarization film and two transparent protective films disposed on both sides thereof. It has, as one of the protective films, the optically compensatory sheet of the invention having the above-described cellulose acylate film. The other protective film may be the optically compensatory sheet of the invention or may be an ordinarily used cellulose acetate film.

The polarization film is, for example, an iodine polarization film, dye polarization film using a dichroic dye, or polyene polarization film. Each of the iodine polarization film and dye polarization film is usually prepared using a polyvinyl alcohol film.

The slow axis of the optically compensator sheet containing the cellulose acylate film is disposed substantially parallel to the transmission axis of the polarization film.

### (Antireflection Layer)

An antireflection layer is preferably disposed on a transparent protective film of a polarizing plate arranged on a side opposite to a liquid crystal cell. In particular in the invention, (1) an antireflection layer having a transparent protective film and a light scattering layer and a low refractive index layer stacked thereover in the order of mention, or (2) an antireflection layer having a transparent protective film and a medium refractive index layer, a high refractive index layer and a low refractive index layer stacked thereover in the order of mention are preferred. The preferred examples of these antireflection layers are described below.

### (1) An Antireflection Layer Having a Transparent Protective Film and a Light Scattering Layer and a Low Refractive Index Layer Stacked Thereover.

Mat particles are dispersed in the light scattering layer. The material of a portion of the light scattering layer other than the mat particles has a refractive index preferably falling within a range of from 1.48 to 2.00, while the low refractive index layer has a refractive index preferably falling within a range of from 1.20 to 1.49. In the invention, the light scattering layer has both anti-glare properties and hard coat properties, and may comprise one layer, or a plurality of layers, for example, two to four layers.

The antireflection layer preferably has sufficient anti-glare properties and a visually uniform mat surface when its surface unevenness is designed so that the center line average roughness Ra ranges from 0.08 to 0.40 μm, the ten point average roughness Rz becomes 10 times as much as Ra or less, the average peak-to-valley distance Sm ranges from 1 to 100 μm, the standard deviation of the height of the convex from the deepest point of the unevenness becomes 0.5 μm or less, the standard deviation of average peak-to-valley distance Sm with the center line as standard becomes 20 μm or less, and a surface with an inclination angle of from 0 to 5 amounts to 10% or more. In addition, when the tint of a reflected light under light source C is −2 to 2 as a* value and −3 to 3 as b* value and a ratio of the minimum value to the maximum value of the reflectance within a range of from 380 to 780 nm is from 0.5 to 0.99, the tint of the reflected light preferably becomes neutral. Further, by adjusting the b* value of the reflected light under light source C to from O to 3, a yellowish color in white display is reduced when the antireflection layer is applied to an image display. When a lattice of 120 μm×40 μm is inserted between a surface light source and the antireflection film of the invention and the standard deviation of luminance distribution measured on the film is 20 or less, glare at the time when a film of the invention is applied to a high precision panel is preferably reduced.

By adjusting the optical properties of the antireflection layer, more specifically, adjusting the mirror reflectivity to 2.5% or less, transmittance to 90% or more, and 60 degree gloss to 70% or less, the antireflection layer can suppress reflection of an outer light and has improved visibility. In particular, the mirror reflectivity is more preferably 1% or less, most preferably 0.5% or less. By adjusting a haze to from 20% to 50%, a ratio of inside haze/total haze to from 0.3 to 1, a reduction of a haze from that at the time of providing a light scattering layer to that at the time of providing a low refractive index layer to 15% or less, the vividness of a transmitted image at the time of comb breadth of 0.5 mm to from 20 to 50%, and a ratio of a light transmitted in a perpendicular direction to a light transmitted in a direction inclined by 2° therefrom to from 1.5 to 5.0, glare on a high precision LCD panel can be prevented and a reduction of blur of letters and the like can be achieved.

### <Low Refractive Index Layer>

The low refractive index layer of the antireflection film has a refractive index of from 1.20 to 1.49, preferably from 1.30 to 1.44. The low refractive index layer preferably satisfies the following equation (VI) in order to reduce the refractive index.

### Equation (VI)

(m/4)×0.7<nldl<(m/4)×1.3 (VI)

wherein, m represents a positive odd number, nl represents a refractive index of a low refractive index layer, dl represents a film thickness (nm) of the low refractive index layer, and λ is wavelength, which is in the range of from 500 to 550 nm.

The materials for forming the low refractive index layer will next be described.

The low refractive index layer in the invention contains a fluorine-containing polymer as a low refractive index binder. The fluorine-containing polymer having a dynamic friction coefficient of from 0.03 to 0.20, a contact angle to water of from 90 to 120°, and a sliding angle of pure water of 70° or less and capable of crosslinking by heat or ionizing radiation is preferred. The polymer has preferably a lower peel force from commercially available adhesive tapes when the antireflection film of the invention is mounted on an image display device, because a sticker, a memo pad and the like easily peels. The peel force is preferably 500 gf or less, more preferably 300 gf or less, most preferably 100 gf or less. The polymer has preferably a high surface hardness as measured by a micro-hardness tester. The greater the surface hardness, the hardly scratched is the surface. It is preferably 0.3 GPa or greater, more preferably 0.5 GPa or greater.

Examples of the fluorine-containing polymers to be used for the low refractive index layer include hydrolysates and dehydration condensates of perfluoroalkyl-containing silane compounds (such as (heptadecafluoro-1,1,2,2-tetrahydrodecyl)triethoxysilane) and fluorine-containing copolymers comprising a fluorine-containing monomer unit and a crosslinking reactivity providing unit.

Specific examples of the fluorine-containing monomer unit include fluoroolefins (such as fluoroethylene, vinylidene fluoride, tetrafluoroethylene, perfluorooctylethylene, hexafluoropropylene, and perfluoro-2,2-dimethyl-1,3-dioxole), partially or completely fluorinated alkyl ester derivatives of (meth)acrylic acid (such as “Viscoat 6FM” (trade name; product of Osaka Organic Chemical Industry) and “M-2020” (trade name; product of Daikin Industries Ltd.)), and completely or partially fluorinated vinyl ethers. Of these, perfluoroolefins are preferred, with hexafluoropropylene being especially preferred from the standpoints of refractive index, solubility, transparency and availability.

Examples of the crosslinking reactivity providing unit include units available by the polymerization of a monomer having, in the molecule thereof, a self-crosslinkable functional group in advance such as glycidyl (meth)acrylate and glycidyl vinyl ether, units available by the polymerization of a monomer having a carboxyl group, hydroxyl group, amino group, or sulfo group (such as (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid), and units available by introducing a crosslinking reactive group such as (meth)acryloyl group to the above-described units by polymer reaction (for example, introducing by acting acrylic acid chloride to a hydroxy group).

In addition to the above-described fluorine-containing monomer units and crosslinking reactivity providing units, monomers free of fluorine atom can be copolymerized as needed from the viewpoints of solubility in a solvent and transparency of a film. No particular limitation is imposed on the monomer units usable in combination. Examples include olefins (such as ethylene, propylene, isoprene, vinyl chloride and vinylidene chloride), acrylates (such as methyl acrylate, ethyl acrylate, and 2-ethylhexyl acrylate), methacrylates (such as methyl methacrylate, ethyl methacrylate, butyl methacrylate and ethylene glycol dimethacrylate), styrene derivatives (such as styrene, divinylbenzene, vinyltoluene, and α-methylstyrene), vinyl ethers (such as methyl vinyl ether, ethyl vinyl ether and cyclohexyl vinyl ether), vinyl esters (such as vinyl acetate, vinyl propionate and vinyl cinnamate), acrylamides (such as N-tert-butylacrylamide and N-cyclohexylacrylamide), methacrylamides, and acrylonitrile derivatives.

Curing agents may be used as needed in combination with the above-described polymers as described in JP-A-10-25388 and JP-A-10-147739.

### <Light Scattering Layer>

The light scattering layer is formed for the purpose of providing a light diffusion property making use of surface scattering and/or subsurface scattering, and a hard coat property to improve scratch resistance of the film. The light scattering layer is therefore formed by containing a binder for providing a hard coat property, mat particles for providing light diffusion property and, if necessary, an inorganic filler for increasing a refractive index, preventing shrinkage by crosslinking, and increasing strength.

The light scattering layer has a thickness of preferably from 1 to 10 μm, more preferably from 1.2 to 6 μm, from the viewpoint of providing it with a hard coat property. Thickness below the above-described range leads to an insufficient hard coat property, while thickness exceeding the above-described range deteriorates curling and brittleness, leading to insufficient processing suitability.

The binder of the light scattering layer is preferably a polymer having, as the main chain thereof, a saturated hydrocarbon chain or a polyether chain, with the former one being more preferred. The binder polymer preferably has a crosslinked structure. As the binder polymers having, as the main chain thereof, a saturated hydrocarbon chain, polymers of an ethylenically unsaturated monomer are preferred. As the binder polymers having, as the main chain thereof, a saturated hydrocarbon chain and also having a crosslinked structure, (co)polymers of a monomer having two or more ethylenically unsaturated groups are preferred. To obtain a binder polymer having an increased refractive index, monomers having, in the structure thereof, an aromatic ring or at least one atom selected from halogen atoms other than fluorine, sulfur atom, phosphorus atom, and nitrogen atom.

Examples of the monomer having two or more ethylenically unsaturated groups include esters of a polyol and (meth)acrylic acid (such as ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetra(meth)acrylate, polyurethane polyacrylate, and polyester polyacrylate), the above-described ethylene oxide-modified products, vinylbenzene and derivatives thereof (such as 1,4-divinylbenzene, 2-acryloylethyl 4-vinylbenzoate, and 1,4-divinylcyclohexanone), vinylsulfones (such as divinylsulfone), acrylamides (such as methylenebisacrylamide), and methacrylamide. These monomers may be used in combination of two or more.

Specific examples of a high refractive index monomer include bis(4-methacryloylthiophenyl)sulfide, vinylnaphthalene, vinyl phenyl sulfide, and methacryloxyphenyl-4-methoxyphenylthioether. These monomers may also be used in combination.

Polymerization of these monomers having an ethylenically unsaturated group can be performed by exposure to ionizing radiation or heating in the presence of a photoradical polymerization initiator or a thermal radical polymerization initiator.

Accordingly, an antireflection film can be formed by preparing a coating solution containing a monomer having an ethylenically unsaturated group, a photoradical polymerization initiator or a thermal radical polymerization initiator, mat particles and an inorganic filler, applying the coating solution onto a transparent support, and then curing it by the polymerization reaction caused by exposure to ionizing radiation or heating. As the photoradical polymerization initiator and the like, known ones are usable.

As polymers having a polyether chain as the main chain thereof, ring opening polymers of a polyfunctional epoxy compound are preferred. Ring opening polymerization of the polyfunctional epoxy compound can be effected by exposure to ionizing radiation or by heating in the presence of a photo-acid generator or a heat-acid generator.

An antireflection film can therefore be formed by preparing a coating solution containing a polyfunctional epoxy compound, a photo-acid generator or a heat-acid generator, mat particles and an inorganic filler, applying the coating solution onto a transparent support, and then curing it by the polymerization reaction caused by ionizing radiation or heating.

Instead of or in addition to the monomer having two or more ethylenically unsaturated groups, a crosslinkable functional group may be introduced into a polymer by using a monomer having a crosslinkable functional group, whereby a crosslinked structure may be introduced into a binder polymer by the reaction of the crosslinkable functional group.

Examples of the crosslinkable functional groups include isocyanate, epoxy, aziridine, oxazoline, aldehyde, carbonyl, hydrazine, carboxyl, methylol and active methylene. Vinylsulfonic acid, acid anhydride, cyano acrylate derivative, melamine, etherified methylol, ester and urethane, and metal alkoxide such as tetramethoxysilane can also be used as monomers for introducing a crosslinked structure. A functional group showing a crosslinking property as a result of decomposition reaction, such as a block isocyanate group, can also be used as a crosslinkable functional group. In the invention, crosslinkable functional group does not necessarily show reactivity but may show reactivity as a result of decomposition.

These binder polymers having a crosslinkable functional group can form a crosslinked structure by heating after application.

For the purpose of imparting an anti-glare property, mat particles having an average particle size of from 1 to 10 μm, preferably from 1.5 to 7.0 μm, which are greater than filler particles, for example, particles of inorganic compounds or resin particles, are contained in the light scattering layer.

Preferred specific examples of the mat particles include particles of inorganic compounds such as silica particles and TiO particles, and resin particles such as acrylic particles, crosslinked acrylic particles, polystyrene particles, crosslinked styrene particles, melamine resin particles, and benzoguanamine resin particles. Of these, crosslinked styrene particles, crosslinked acrylic particles, crosslinked acrylstyrene particles, and silica particles are preferred.

The mat particles in either the spherical or amorphous form can be used.

Further, two or more mat particles different in particle size may be used together. It is possible to give an antiglare property by mat particles having a greater particle size and give another optical property by mat particles having a smaller particle size.

The particle size distribution of the mat particles is most preferably monodispersion. The more uniform the particle sizes of all the particles, the better. Assuming that particles having particle sizes greater by at least 20% than the average particle size are defined as coarse particles, the proportion of the coarse particles is preferably 1% or less of the number of all the particles, more preferably 0.1% or less, still more preferably 0.01% or less. Mat particles having such particle size distribution are available by classifying after ordinary synthesis reaction. By increasing the classifying frequency or raising the classifying degree, mat particles having more preferred particle size distribution can be obtained.

The mat particles are added to the light scattering layer so that the amount contained therein is preferably from 10 to 1000 mg/m², more preferably from 100 to 700 mg/m² in terms of the amount after formation. The particle size distribution of the mat particles is measured by the Coulter counter technique and the particle size distribution thus measured is converted into particle number distribution.

For increasing the refractive index of the light scattering layer, an inorganic filler, as well as the above-described mat particles, is preferably added thereto. The inorganic filler comprises an oxide of at least one metal selected from titanium, zirconium, aluminum, indium, zinc, tin and antimony, and has an average particle size of 0.2 μm or less, preferably 0.1 μm or less, more preferably 0.06 μm or less.

In the light scattering layer containing high refractive index mat particles, on the other hand, silicon oxide for maintaining the refractive index of the layer at a low level may preferably be used in order to increase a difference in the refractive index between the layer and the mat particles. The preferred particle size is similar to that of the above-described inorganic filler.

Specific examples of the inorganic filler for use in the light scattering layer include TiO₂, ZrO₂, Al₂O₃, In₂O₃, ZnO, SnO₂, Sb₂O₃, ITO and SiO₂. Of these, TiO₂ and ZrO₂ are especially preferred for increasing a refractive index. The surface of the inorganic filler is preferably subjected to silane coupling treatment or titanium coupling treatment. A surface treatment agent imparting a functional group reactive with the binder to the surface of the filler is preferred.

The inorganic filler is added in an amount of preferably from 10 to 90%, more preferably from 20 to 80%, especially preferably from 30 to 75% of the entire mass of the light scattering layer.

Such a filler does not cause scattering because its particle size is small enough compared with the wavelength of a light and a dispersion of the filler in the binder polymer behaves as an optically uniform substance.

A mixture, as a bulk, of the binder and inorganic filler in the light scattering layer has a refractive index of preferably from 1.48 to 2.00, more preferably from 1.50 to 1.80. The refractive index can be controlled to fall within the above-described range only by selecting the kind or ratio of the binder and the inorganic filler as needed. It can be selected easily by tests made in advance.

For securing planar uniformity free of coating unevenness, drying unevenness and point defects, the light scattering layer contains a fluorine surfactant or silicone surfactant or both of them in a coating composition for forming an antiglare layer. The fluorine surfactant is especially preferred because addition of it in a smaller amount is effective for alleviating planar troubles such as coating unevenness, drying unevenness and point defects of the antireflection film of the invention. The object of the addition of the surfactant is to increase productivity by making it suitable for high speed application while increasing the planar uniformity.

### (2) An Antireflection Layer Having a Transparent Protective Film and a Medium Refractive Index Layer, High Refractive Index Layer and Low Refractive Index Layer Stacked Thereover in the Order of Mention

An antireflection layer comprising a medium refractive index layer, high refractive index layer, and low refractive index layer (outermost layer) stacked in the order of mention over a base (which means a transparent protective film. The term “base”, “base material” or “transparent support” as used herein means a transparent protective film. The term “antireflection film” means a film having an antireflection layer on a base) is designed to have a refractive index satisfying the below-described relationship.

Refractive index of a high refractive index layer>Refractive index of a middle refractive index layer>Refractive index of a transparent support>Refractive index of a low refractive index layer.

A hard coat layer may be provided between a transparent support and a middle refractive index layer. Further, the antireflection layer may comprise a middle refractive index hard coat layer, high refractive index layer, and low refractive index layer.

Examples include JP-A-8-122504, JP-A-8-110401, JP-A-10-300902, JP-A-2002-243906 and JP-A-2000-111706. Each layer may have another function. An antifouling low refractive index layer and an antistatic high refractive index layer (as described in JP-A-10-206603 and JP-A-2002-243906) can be given as examples.

The antireflection layer has a haze of preferably 5% or less, more preferably 3% or less. The film strength is preferably H or higher, more preferably 2H or higher, most preferably 3H or higher, as a result of the pencil hardness test according to JIS K5400.

### <High Refractive Index Layer and Middle Refractive Index Layer>

A layer of the antireflection film having a high refractive index is made of a curable film containing at least ultrafine particles of a high refractive index inorganic compound having an average particle size of 100 nm or less and a matrix binder.

The ultrafine particles of the high refractive index inorganic compound are, for example, inorganic compounds having a refractive index of 1.65 or greater, preferably 1.9 or greater. Examples include oxides of Ti, Zn, Sb, Sn, Zr, Ce, Ta, La and In, and compound oxides containing these metal atoms.

Such superfine particles can be obtained by treating the surfaces of the particles with a surface treating agent (for example, with a silane coupling agent as disclosed in JP-A-11-295503, JP-A-11-153703 and JP-A-2000-9908, with an anionic compound or organic metal coupler as disclosed in JP-A-2001-310432), by forming a core/shell structure with high refractive index particles as the core (JP-A-2001-166104), or by using a specific dispersant in combination (for example, JP-A-11-153703, U.S. Pat. No. 6,210,858 and JP-A-2002-2776069).

Examples of the material forming the matrix include conventionally known thermoplastic resins and thermosetting resins.

Further, at least one composition selected from polyfunctional-compound-containing compositions having at least two radical polymerizable groups and/or cationic polymerizable groups, organic metal compounds having a hydrolyzable group, and partial condensate compositions thereof is preferred. Examples include the compositions described in JP-A-2000-47004, JP-A-2001-315242, JP-A-2001-31871 and JP-A-2001-296401.

Further, curable films available from colloidal metal oxides available from hydrolysis condensates of a metal alkoxide and a metal alkoxide composition are also preferred. They are disclosed, for example, in JP-A-2001-293818.

The high refractive index layer usually has a refractive index of from 1.70 to 2.20. It has a thickness of preferably from 5 nm to 10 μm, more preferably from 10 nm to 1 μm.

The middle refractive index layer has a refractive index adjusted to fall between that of a low refractive index layer and that of the high refractive index layer. The middle refractive index layer has a refractive index of preferably from 1.50 to 1.70 and a thickness of preferably from 5 nm to 10 μm, more preferably from 10 nm to 1 μm.

### <Low Refractive Index Layer>

A low refractive index layer is stacked over the high refractive index layer. The low refractive index layer has a refractive index of from 1.20 to 1.55, preferably from 1.30 to 1.50.

The low refractive index layer is preferably formed as the outermost layer having scratch resistance and an antifouling property. Addition of a sliding property to its surface is effective to improve the scratch resistance greatly. Conventionally known methods employed for the formation of a thin-film layer such as introduction of silicon or fluorine can be applied to it.

The fluorine-containing compound has a refractive index of preferably from 1.35 to 1.50, more preferably from 1.36 to 1.47. The fluorine-containing compound preferably contains a crosslinkable or polymerizable functional group containing fluorine atoms in an amount of from 35 to 80 mass %.

Examples include the compounds described in paragraphs [0018] to [0026] of JP-A-9-222503, paragraphs [0019] to [0030] of JP-A-11-38202, paragraphs [0027] and of JP-A-2001-40284, and JP-A-2000-284102.

Silicone compounds preferably have a polysiloxane structure; contain, in the high molecular chain thereof, a curable functional group or a polymerizable functional group; and have a crosslinked structure in the film. Examples include reactive silicone (such as “Silaplane” trade name; product of Chisso Corporation), and polysiloxane containing silanol groups at both ends thereof (such as JP-A-11-258403).

The crosslinking reaction or polymerization reaction of a fluorine-containing and/or siloxane polymer having a crosslinkable group or a polymerizable group is performed by exposure to light or heating simultaneously with or immediately after a coating composition, for the formation of the uppermost layer, containing a polymerization initiator and a sensitizer is applied.

A sol-gel curable film which cures by the condensation reaction of an organic metal compound such as a silane coupler and a specific silane coupler containing fluorine and a hydrocarbon group in the presence of a catalyst is also preferred.

Examples include polyfluoroalkyl-containing silane compounds or partially hydrolysis condensates thereof (the compounds described in JP-A-58-142958, JP-A-58-147483, JP-A-58-147484, JP-A-9-157582 and JP-A-11-106704), and silyl compounds containing a poly(perfluoroalkyl ether) group which is a fluorine-containing long chain group (the compounds described in JP-A-2000-117902, JP-A-2001-48590 and JP-A-2002-53804).

The low refractive index layer may contain, in addition to the above-described additives, low refractive index inorganic compounds having an average primary particle size of from 1 to 150 nm such as fillers (for example, silicon dioxide (silica), fluorine-containing particles (e.g., magnesium fluoride, calcium fluoride and barium fluoride), and organic fine particles described in paragraphs from [0020] to [0038] of JP-A-11-3820), silane coupling agents, lubricants and surfactants.

When the low refractive index layer is formed as the outermost lower layer, it may be formed by the gas phase method (such as vacuum deposition, sputtering, ion plating or plasma CVD). The method of application is preferred because it enables the formation at a low cost.

The low refractive index layer has a thickness of preferably from 30 to 200 nm, more preferably from 50 to 150 nm, most preferably from 60 to 120 nm.

(3) Layers Other than the Antireflection Layer

In addition, a hard coat layer, forward scattering layer, primer layer, antistatic layer, undercoat layer and protective layer may be provided.

### <Hard Coat Layer>

A hard coat layer is provided on the surface of the transparent support for the purpose of giving physical strength to the transparent protective film having thereover the antireflection layer. The hard coat layer is preferably inserted between the transparent support and the high refractive index layer.

The hard coat layer is preferably formed by a crosslinking reaction or a polymerization reaction of a photo- and/or thermo-curable compound.

As the curable functional group, photo-polymerizable functional groups are preferred, and as the organic metal compound containing a hydrolyzable functional group, organic alkoxysilyl compounds are preferred.

Specific examples of these compounds are similar to those given in the description of the high refractive index layer. Examples of the constituent composition of the hard coat layer include compositions described in JP-A-2002-144913, JP-A-2000-9908 and WO 00/46617.

The high refractive index layer can also serve as the hard coat layer. In such a case, the hard coat layer can be formed by adding finely dispersed particles to the hard coat layer according to the method as described in the high refractive index layer.

The hard coat layer can also serve as an antiglare layer (described later) having an antiglare function by containing particles having an average particle size of from 0.2 to 10 μm.

The thickness of the hard coat layer can be designed properly according to the using purpose. The hard coat layer has a thickness of preferably from 0.2 to 10 μm, more preferably from 0.5 to 7 μm.

The hard coat layer has a strength of preferably H or higher as a result of the pencil hardness test according to JIS K5400, more preferably 2H or higher, and most preferably 3H or higher. In a Taber abrasion test according to JIS K5400, the abrasion loss of a test piece before and after the test is preferably as small as possible.

### <Antistatic Layer>

When an antistatic layer is provided, a volume resistivity of 10⁻⁸ (Q cm⁻³) or less is preferably imparted thereto as conductivity. The volume resistivity of 10⁻⁸ (Q cm⁻³) or less can be imparted using a hygroscopic material, water-soluble inorganic salt, certain surfactant, cationic polymer, anionic polymer or colloidal silica. Since dependence on temperature and humidity is large, sufficient conductivity cannot be given at low humidity. Metal oxides are therefore preferred as the material for the conductive layer. Some metal oxides are stained, and stained metal oxides are not preferred because they may stain the whole film. Examples of metals capable of forming stain-free metal oxides include Zn, Ti, Al, In, Si, Mg, Ba, MO, W and V. Use of metal oxides composed mainly of them is preferred. Specific preferred examples include ZnO, TiO₂, SnO₂, Al₂O₃, In₂O₃, SiO₂, MgO, BaO, MoO, V₂O₅, and compound oxides thereof. Of these, ZnO, TiO₂ and SnO₂ are especially preferred. As metal oxides containing another atom, ZnO added with Al or In, SnO₂ added with Sb, Nb or halogen element, and TiO₂ added with Nb or TA are effective. Furthermore, as described in JP-B-59-6235, materials obtained by attaching the above metal oxide to other crystalline metal particles or fibrous substances (such as titanium oxide) may be used. Although a volume resistivity and a surface resistivity are different physical values and they cannot be compared easily, the surface resistivity of the conductive layer is basically adjusted to 10−8 (Q/□) or less, preferably 10−8 (Q/□) or less in order to secure a volume resistivity of 10⁻⁸ (Q cm⁻³) or less as its conductivity. The surface resistivity of the conductive layer must be measured as a value at the time when the antistatic layer is disposed as the outermost layer, and this value can be obtained during the formation of the film stack as described in this specification.

### [Liquid Crystal Display Device]

The liquid crystal display device of the invention is characterized that it has a liquid crystal cell and two polarizing plates placed on both sides thereof and at least one of the polarizing plates is the polarizing plate of the invention.

The polarizing plate using the cellulose acylate film of the invention can be used advantageously for the liquid crystal display device. The polarizing plate of the invention can be used for liquid cells of various display modes. Examples of the display mode proposed now include TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), and HAN (Hybrid Aligned Nematic). Of these modes, the polarizing plate of the invention is suited for use in an OCB mode or VA mode.

An OCB mode liquid crystal cell is a liquid crystal display device using a liquid crystal cell of bend orientation mode in which rod-like liquid crystal molecules are oriented in substantially reverse directions (symmetrically) at the upper and lower parts of the liquid crystal cell. The OCB mode liquid cell is disclosed in U.S. Pat. Nos. 4,583,825 and 5,410,422. Since rod-like liquid crystal molecules are orientated symmetrically at the upper and lower parts of the liquid crystal cell, the liquid crystal cell of bend orientation mode has a self optical compensation function. This liquid crystal mode is therefore called OCB (Optically Compensatory Bend) liquid crystal mode. The liquid crystal display device of a bend orientation mode has an advantage of high response speed.

In a VA mode liquid crystal cell, rod-like liquid crystal molecules are substantially perpendicularly orientated when no voltage is applied.

The VA mode liquid crystal cell includes (1) a VA mode liquid crystal cell in a narrow sense in which rod-like liquid crystal molecules are aligned substantially perpendicularly when no voltage is applied and are oriented substantially horizontally when voltage is applied (as described in JP-A-2-176625), (2) a liquid crystal cell (of MVA mode) in which the VA mode is modified to be multi-domain type so as to enlarge the viewing angle (SID97, Digest of Tech. Papers (Preprint), 28, 845 (1997)), (3) a liquid crystal cell of a mode (n-ASM mode) in which rod-like liquid crystal molecules are oriented substantially perpendicularly when voltage is not applied and oriented in twisted multi-domain alignment while voltage is applied (Reprint of Nippon Ekisho Toronkai (Japan Liquid Crystal Symposium), 58-59 (1998)), and (4) a liquid crystal cell of SURVIVAL mode (presented at LCD International 98).

OCB mode and VA mode liquid crystal display devices may have a liquid crystal cell and two polarizing plates disposed on both sides thereof. The VA mode liquid crystal display device may have a polarizing plate disposed on the backlight side of the cell. The liquid crystal cell carries liquid crystals between two electrode substrates.

The liquid crystal display device of the invention will hereinafter be described referring to accompanying drawings.

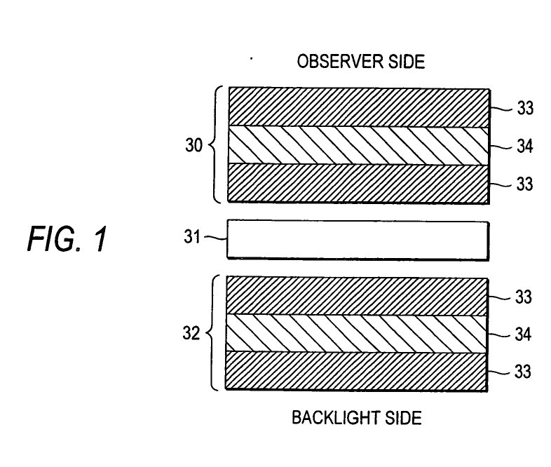

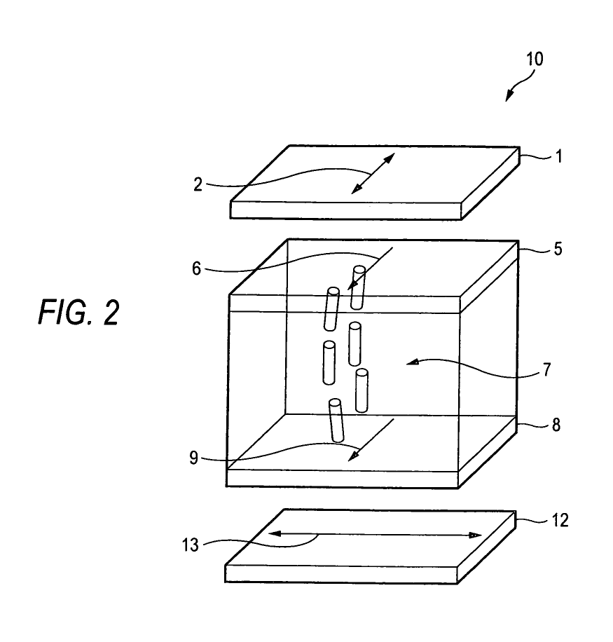

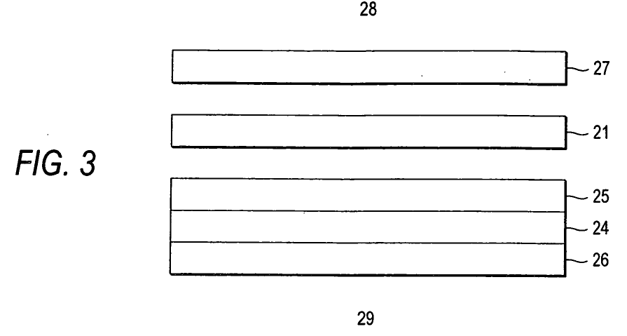

FIG. 1 is a schematic view illustrating one exemplary example of the liquid crystal display device of the invention; FIG. 2 is a schematic view illustrating another exemplary example of the liquid crystal display device of the invention; and FIG. 3 is a schematic view illustrating a further exemplary example of the liquid crystal display device of the invention.

The liquid crystal display device illustrated in FIG. 1 is obtained by attaching an upper-side polarizing plate 30 to one side of a VA mode liquid crystal cell 31 and a lower-side polarizing plate 32 to the other side. These polarizing plates 30 and 32 are each obtained by attaching cellulose acylate films 33 to both sides of a polarizer 34.

The liquid crystal display device 10 illustrated in FIG. 2 is obtained by attaching a liquid-cell upper electrode substrate 5 and a liquid-cell lower electrode substrate 8 to both sides of a liquid crystal layer 7, thereby forming a liquid crystal cell. An upper polarizing plate 1 and a lower polarizing plate 12 are then attached to both sides of the liquid crystal cell. The direction 2 of the absorption axis of the upper polarizing plate, the orientation controlling direction 6 of the upper substrate, the orientation controlling direction 9 of the lower substrate, and the direction 13 of the absorption axis of the lower polarizing plate are each as illustrated in FIG. 2.

FIG. 3 is an application example of the polarizing plate of the invention having an optically compensatory sheet 25 of the invention to a liquid crystal display device. The polarizing plate has the optically compensatory sheet 25 stacked on the VA liquid crystal cell side of a polarizer 24 and a protective film 26 on the side opposite thereto of the polarizer 24 and it is used while being placed on the backlight side. In the example of FIG. 3, “HLC2-5618” (trade name; product of SANRITZ CORPORATION) is used as a polarizing plate 27 on the observer side (viewing side), but the polarizing plate is not limited thereto.

### EXAMPLES

The characteristics of the invention will be described more specifically by Examples and Comparative Examples. It should however be borne in mind that the materials, using amounts and rates thereof, treatment details, and processing procedures shown in the following Examples can be changed as needed insofar as they do not depart from the scope of the invention. The range of the invention is therefore not construed as being limited by the specific examples set forth herein.

### Example 1

### Preparation of Cellulose Acylate Film 101

### <Preparation of Cellulose Acetate Solution>

A cellulose acetate solution 101 was prepared by charging the following composition in a mixing tank and dissolving the components by stirring.

### (Composition of the Cellulose Acetate Solution 01)

| | | |
|---|---|---|
| Cellulose acetate propionate | 100.0 | parts by mass |
| (acetylation degree: 1.91, propynylation degree: | | |
| 0.80) | | |
| Triphenyl phosphate (plasticizer) | 8.0 | parts by mass |
| Ethyl phthalyl ethyl glycolate (plasticizer) | 2.0 | parts by mass |
| Ethylene chloride (first solvent) | 402.0 | parts by mass |
| Ethanol (second solvent) | 60.0 | parts by mass |

### <Preparation of a Matting Agent Solution 11>

A matting agent solution was prepared by charging the following composition in a dispersing machine, and dispersing and mixing the components by stirring.

### (Composition of Matting Agent Solution 11)

| | |
|---|---|
| Silica particles having an average particle | 2.0 parts by mass |
| size of 20 nm (“AEROSIL R972”, trade name; | |
| product of Nippon Aerosil) | |
| Methylene chloride (first solvent) | 75.0 parts by mass |
| Ethanol (second solvent) | 12.7 parts by mass |
| Cellulose acylate solution 01 | 10.3 parts by mass |

### <Preparation of Ultraviolet Absorber Solution 21>

An ultraviolet absorber solution was prepared by charging the following composition in a mixing tank, and stirring under heat to dissolve the components.

### (Composition of Ultraviolet Absorber Solution 21)

| | |
|---|---|
| TINUVIN 171 | 10.0 parts by mass |
| TINUVIN 109 | 10.0 parts by mass |
| Methylene chloride (first solvent) | 67.2 parts by mass |
| Ethanol (second solvent) | 10.0 parts by mass |
| Cellulose acylate solution 01 | 12.8 parts by mass |

After filtration of each of 1.3 parts by mass of the matting agent solution and 1.7 parts by mass of the ultraviolet absorber solution, they were mixed in an in-line mixer. To the resulting mixture was added 97.0 parts by mass of the cellulose acylate solution, followed by mixing in the in-line mixer. The resulting mixture was cast using a band casting machine and dried at 100° C. until a residual solvent content decreased to 30%. The film was then peeled off and stretched at a stretch ratio of 20% in a longitudinal direction and 60% in a width direction at an atmospheric temperature of 140° C. The film was then retained for 30 seconds at 140° C. The residual solvent content when the stretching was started was 25%. After a clip was removed, the film was dried at 30° C. for 40 minutes, whereby a cellulose acylate film 101 was prepared. The cellulose acylate film 101 thus obtained had a residual solvent content of 0.1% and film thickness of 50 μm.

### Examples 2 to 8

### Preparation of Cellulose Acylate Films 102 to 108

In a similar manner to that employed for the preparation of the cellulose acylate film 101 except that the kind of the cellulose acylate, kind/amount of the plasticizer, kind/amount of the ultraviolet absorber and stretch ratio were changed as shown in Table 1, cellulose acylate films 102 to 108 were prepared.

### Comparative Examples 1 to 4

### Preparation of Cellulose Acylate Films 201 to 204

In a similar manner to that employed for the preparation of the cellulose acylate film 101 except that the kind of the cellulose acylate, kind/amount of the plasticizer, kind/amount of the ultraviolet absorber and stretch ratio were changed as shown in Table 1, cellulose acylate films 201 to 204 of Comparative Examples were prepared.

TABLE 1

| | Total degree of substitution | | | Degree of 6-substitution of | | | Molecular weight of | | | | | | |
|---|---|---|---|---|---|---|---|---|---|---|---|---|---|
| | of cellulose acylate | | | cellulose acylate | | | cellulose acylate | | | Plasticizer | | | |
| Film | (DS2 + DS3 + DS6) | | | DS6/(DS2 + DS3 + DS6) | | | | | Mw/ | 1 | | Plasticizer 2 | |
| No. | Acetyl | Propionyl | Benzoyl | Acetyl | Propionyl | Benzoyl | Mn | Mw | Mn | Kind | Amt^{d)} | Kind | Amt^{d)} |
| 101 | 1.91 | 0.80 | 0.00 | 0.33 | 0.34 | — | 80000 | 240000 | 3.0 | TPP^{a)} | 8.0 | EPEG^{b)} | 2.0 |
| 102 | 1.88 | 0.83 | 0.00 | 0.27 | 0.48 | — | 80000 | 240000 | 3.0 | TPP | 9.0 | EPEG | 2.0 |
| 103 | 2.19 | 0.00 | 0.46 | 0.29 | — | 0.78 | 75000 | 255000 | 3.4 | TPP | 7.0 | BDP^{c)} | 3.5 |
| 104 | 2.39 | 0.0 | 0.37 | 0.28 | — | 0.86 | 85000 | 212500 | 2.5 | TPP | 9.0 | BDP | 2.0 |
| 105 | 1.68 | 1.00 | 0.00 | 0.33 | 0.34 | — | 70000 | 168000 | 2.4 | TPP | 9.0 | BDP | 2.0 |
| 106 | 1.68 | 1.00 | 0.00 | 0.31 | 0.4 | — | 70000 | 168000 | 2.4 | TPP | 9.0 | BDP | 2.0 |
| 107 | 2.19 | 0.00 | 0.46 | 0.29 | — | 0.78 | 75000 | 255000 | 3.4 | TPP | 7.0 | BDP | 3.5 |
| 108 | 2.19 | 0.00 | 0.46 | 0.29 | — | 0.78 | 75000 | 255000 | 3.4 | TPP | 7.0 | BDP | 3.5 |
| 201 | 1.91 | 0.80 | 0.00 | 0.33 | 0.34 | — | 80000 | 240000 | 3.0 | TPP | 8.0 | EPEG | 2.0 |
| 202 | 1.91 | 0.80 | 0.00 | 0.33 | 0.34 | — | 80000 | 240000 | 3.0 | TPP | 8.0 | EPEG | 2.0 |
| 203 | 1.91 | 0.80 | 0.00 | 0.33 | 0.34 | — | 85000 | 255000 | 3.0 | TPP | 9.0 | BDP | 2.0 |
| 204 | 2.88 | 0.0 | 0.0 | 0.33 | — | — | 85000 | 212500 | 2.5 | TPP | 9.0 | BDP | 2.0 |

| | Ultraviolet absorber 1 | | | Ultraviolet absorber 2 | | | Stretch ratio | | Film | |
|---|---|---|---|---|---|---|---|---|---|---|
| Film | | Melting | | | Melting | | Width | Longitudinal | thickness | |
| No. | Kind | point | Amt^{d)} | Kind | point | Amt^{d)} | direction | direction | (μm) | Note |
| 101 | TINUVIN 171 | ≦25° | 1.0 | TINUVIN 109 | ≦25° | 1.0 | 60 | 20 | 50 | Invention |
| 102 | TINUVIN 171 | ≦25° | 2.0 | TINUVIN 109 | ≦25° | 2.0 | 65 | 25 | 45 | Invention |
| 103 | TINUVIN 171 | ≦25° | 0.5 | TINUVIN 109 | ≦25° | 1.2 | 65 | 10 | 42 | Invention |
| 104 | TINUVIN 171 | ≦25° | 0.5 | TINUVIN 109 | ≦25° | 1.2 | 80 | 20 | 42 | Invention |
| 105 | TINUVIN 171 | ≦25° | 0.5 | TINUVIN 109 | ≦25° | 1.2 | 80 | 20 | 62 | Invention |
| 106 | TINUVIN 171 | ≦25° | 0.5 | TINUVIN 109 | ≦25° | 1.2 | 80 | 20 | 62 | Invention |
| 107 | TINUVIN 171 | ≦25° | 0.5 | TINUVIN 109 | ≦25° | 1.2 | 50 | 30 | 66 | Invention |
| 108 | TINUVIN 171 | ≦25° | 0.5 | TINUVIN 109 | ≦25° | 1.2 | 65 | 10 | 67 | Invention |
| 201 | TINUVIN 171 | ≦25° | 1.0 | TINUVIN 109 | ≦25° | 1.0 | 30 | 0 | 75 | Comp. |
| 202 | TINUVIN 326 | ≧30° | 3.0 | TINUVIN 109 | ≦25° | 1.0 | 30 | 0 | 78 | Comp. |
| 203 | TINUVIN 326 | ≧30° | 3.0 | TINUVIN 109 | ≦25° | 1.0 | 30 | 0 | 50 | Comp. |
| 204 | TINUVIN 171 | ≦25° | 0.5 | TINUVIN 109 | ≦25° | 1.2 | 25 | 0 | 92 | Comp. |

^{a)}TPP: triphenyl phosphate,
^{b)}EPEG: ethyl phthalyl ethyl glycolate,
^{c)}BDP: biphenyl diphenyl phosphate,
^{d)}mass % relative to cellulose acylate

### [Measurement of Retardation]

The Re retardation and Rth retardation, at 446 nm, 548 nm and 629 nm, of the cellulose acylate films thus prepared were measured using “KOBRA WR” (trade name; product of Oji Scientific Instruments).

### [Measurement of Haze]

The haze of a 40 mm×80 mm film sample was measured at 25° C. and 60% RH by using a haze meter (“HGM-2DP”, trade name; product of Suga Test Instruments).

### [Measurement of Orientation Degree of Cellulose Molecular Chain]

X-ray was generated at 40 kV-36 mA by “RINT RAPID” (trade name; product of Rigaku Corporation) while using a Cu tube as an X-ray source. The beam size of a collimator was 0.8 mm and a film sample was fixed to a transmission sample stand. Exposure time was adjusted to 600 seconds. The degree Po of in-plane orientation of the film and degree Pth of orientation in a film thickness direction were thus measured.

The results are shown in Table 2.

TABLE 2

| | Re (nm) | | | | | Rth | | | | |
|---|---|---|---|---|---|---|---|---|---|---|
| Film | | | | Re(446)/ | Re(629)/ | | | | Re(446)/ | Re(629)/ |
| No. | Re (446) | Re (548) | Re (629) | Re(548) | Re(548) | Rth (446) | Rth (548) | Rth (629) | Re(548) | Re(548) |
| 101 | 38 | 43 | 46 | 0.88 | 1.07 | 113 | 123 | 129 | 0.92 | 1.05 |
| 102 | 35 | 40 | 44 | 0.88 | 1.10 | 117 | 130 | 138 | 0.90 | 1.06 |
| 103 | 36 | 44 | 50 | 0.82 | 1.14 | 104 | 117 | 126 | 0.89 | 1.08 |
| 104 | 36 | 48 | 56 | 0.75 | 1.17 | 115 | 135 | 148 | 0.85 | 1.10 |
| 105 | 39 | 53 | 62 | 0.74 | 1.17 | 104 | 124 | 136 | 0.84 | 1.10 |
| 106 | 42 | 58 | 69 | 0.72 | 1.19 | 107 | 129 | 143 | 0.83 | 1.11 |
| 107 | 33 | 38 | 42 | 0.87 | 1.11 | 156 | 172 | 181 | 0.91 | 1.05 |
| 108 | 51 | 57 | 62 | 0.89 | 1.08 | 150 | 158 | 166 | 0.95 | 1.05 |
| 201 | 37 | 39 | 40 | 0.95 | 1.03 | 116 | 122 | 126 | 0.95 | 1.03 |
| 202 | 41 | 42 | 42 | 0.98 | 1.00 | 120 | 122 | 123 | 0.98 | 1.01 |
| 203 | 21 | 22 | 34 | 0.95 | 1.05 | 72 | 77 | 80 | 0.94 | 1.04 |
| 204 | 4 | 5 | 6 | 0.80 | 1.20 | 48 | 52 | 53 | 0.92 | 1.02 |

Orientation degree of cellulose acylate molecular chain

| | | | Average Po of | (Po of the film surface)/ | | |
|---|---|---|---|---|---|---|
| Film | | Po of the film | the entire film | (Average Po of the entire | | |
| No. | Haze | surface | thickness | film thickness) | Pth | Note |
| 101 | 0.6 | 0.043 | 0.04 | 1.2 | 0.13 | Invention |
| 102 | 0.5 | 0.045 | 0.04 | 1.1 | 0.15 | Invention |
| 103 | 0.5 | 0.06 | 0.05 | 1.1 | 0.13 | Invention |
| 104 | 0.4 | 0.066 | 0.06 | 1.1 | 0.16 | Invention |
| 105 | 0.4 | 0.062 | 0.05 | 1.3 | 0.16 | Invention |
| 106 | 0.6 | 0.062 | 0.05 | 1.3 | 0.16 | Invention |
| 107 | 0.7 | 0.030 | 0.02 | 1.3 | 0.15 | Invention |
| 108 | 0.7 | 0.052 | 0.04 | 1.4 | 0.11 | Invention |
| 201 | 1.3 | 0.037 | 0.02 | 1.5 | 0.10 | Comp. |
| 202 | 1.1 | 0.038 | 0.03 | 1.5 | 0.11 | Comp. |
| 203 | 0.6 | 0.044 | 0.04 | 1.2 | 0.13 | Comp. |
| 204 | 0.7 | 0.03 | 0.02 | 1.5 | 0.11 | Comp. |

The results of Table 2 have revealed that in the invention, the Re and Rth both tend to increase at a longer wavelength and desired cellulose acylate films having a low haze can be obtained.

### Example 9

### Preparation of Polarizing Plate 101

### (Saponification Treatment of Cellulose Acylate Film)

The cellulose acylate film 101 prepared in Example 1 was dipped in a 1.3 mol/L aqueous sodium hydroxide solution at 55° C. for 2 minutes, washed in a water washing tank of room temperature, neutralized with 0.05 mol/L of sulfuric acid at 30° C., washed again in a water washing tank of room temperature, and then dried with hot air of 100° C. The surface of the cellulose acylate film 101 was saponified in the above-described manner and provided for the below-described preparation of a polarizing plate sample.

A commercially available cellulose triacetate film (“Fujitack TD80UF”, trade name; product of Fuji Photo Film) was saponified under similar conditions and provided for the below-described preparation of the polarizing plate sample.

### (Preparation of Polarizer)

Iodine was adsorbed to a stretched polyvinyl alcohol film to prepare a polarizer. An optically compensatory sheet made of the cellulose acylate film 101, which had been subjected to the above-described saponification treatment, was adhered as a transparent protective film to one side of the polarizer. They were disposed so that the transmission axis of the polarizer and slow axis of the cellulose acylate film became parallel to each other.

The cellulose triacetate film subjected to the above-described saponification treatment was adhered to the opposite side of the polarizer with a polyvinyl alcohol adhesive, whereby a polarizing plate 101 was prepared.

### Example 10

### Preparation of Polarizing Plates 102 to 108

In a similar manner to that employed for the preparation of the polarizing plate 101 except for the use of the cellulose acylate films 102 to 108, polarizing plates 102 to 108 were prepared, respectively.

### Comparative Example 5

### Preparation of Polarizing Plates 201 to 204

In a similar manner to that employed for the preparation of the polarizing plate 101 except for the use of the cellulose acylate films 201 to 204, polarizing plates 201 to 204 were prepared, respectively.

### Example 11

### Preparation of VA Liquid Crystal Display Device and Evaluation 1

### (Preparation of Liquid Crystal Cell)

To 100 parts by mass of a 3 mass % aqueous polyvinyl alcohol solution was added 1 part by mass of octadecyldimethylammonium chloride (coupler). The resulting mixture was spin coated onto a glass substrate equipped with an ITO electrode, followed by heat treatment at 160° C. By the rubbing treatment, an orientation film for vertical alignment was prepared. The two glass substrates were rubbed in directions opposite to each other. These two glass substrates were faced to form a cell gap (d) of 5 μm. A liquid crystal compound (Δn: 0.08) composed mainly of ester and ethane liquid crystal molecules was injected into the cell gap to prepare a liquid crystal cell of a vertical alignment mode. The product of Δn and d was 410 nm.

The polarizing plate 101 was adhered onto each surface of the liquid crystal cell of a vertical alignment mode, whereby the liquid crystal display device 101 was prepared.

In a similar manner to that employed for the preparation of the liquid crystal display device 101 except for the use of the polarizing plates 201 and 203 of Comparative Examples, liquid crystal display devices 201 and 203 were prepared, respectively.

### (Shift in Viewing Angle of Tint)

A tint shift of each of the resulting liquid crystal display devices (101), (201) and (203) between a direction angle of 0° and a direction angle of 80° was measured at a polar angle of 60° by “Ezcontrast” (trade name; product or ELDIM) and a front contrast and absolute values Δx and Δy of a tint shift on an xy chromaticity diagram were determined. As a result, the liquid crystal display device (101) of the invention was preferred because it had a high front contrast and had a small tint shift between two viewing angles, while the liquid crystal display device (201) had a low front contrast and the liquid crystal display device (203) had a small color shift between two viewing angles.

### Example 12

### Preparation of a Polarizing Plate having an Optically Compensatory Function

(1) Preparation of an Optically Compensatory Sheet having an Optically Anisotropic Layer

### (Saponification Treatment B of Cellulose Acylate Film)

A saponification solution having the below-described composition was applied in an amount of 5.2 mL/m² to the cellulose acylate film 107 prepared in Example 2, followed by drying at 60° C. for 10 seconds. The film surface was washed for 10 seconds with running water and was dried by blowing air of 25° C. thereto.

### (Composition of Saponification Solution)

| | |
|---|---|
| Isopropyl alcohol | 818 parts by mass |
| Water | 167 parts by mass |
| Propylene glycol | 187 parts by mass |
| “EMALEX” (trade name; product | 10 parts by mass |
| of Nippon Emulsion) | |
| Potassium hydroxide | 67 parts by mass |

### (Formation of Orientation Film)

A coating solution (24 mL/m²) having the below-described composition was applied by a wire bar coater #14 to the cellulose acylate film 107 which had been subjected to saponification treatment. The resulting film was dried at a hot wind of 60° C. for 60 seconds and then a hot wind of 90° C. for 150 seconds.

Rubbing treatment was then given to the film thus formed in a direction of 45° against a stretching direction (substantially equal to a slow axis) of the cellulose acylate film 107.

### (Composition of the Orientation Film Coating Solution)

(Composition of the orientation film coating solution)

| | |
|---|---|
| Modified polyvinyl alcohol having the | 20 parts by mass |
| below-described structure | |
| Water | 360 parts by mass |
| Methanol | 120 parts by mass |
| Glutaraldehyde (crosslinking agent) | 1.0 parts by mass |

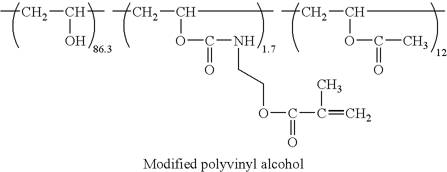

### (Formation of Optically Anisotropic Layer)

A coating solution (5.2 mL/m²) obtained by dissolving, in 214.2 parts by mass of methyl ethyl ketone, 91 parts by mass of a discotic compound having the below-described structure, 9 parts by mass of ethylene-oxide-modified trimethylolpropane triacrylate (“V#360”, trade name; product of Osaka Organic Chemical), 1.5 parts by mass of cellulose acetate butyrate (“CAB 531-1” trade name; product of Eastman Chemical), 3 parts by mass of an optical polymerization initiator (“Irgacure 907”, trade name; product of Ciba Geigy) and 1 part by mass of a sensitizer (“Kayacure DETX”, trade name; product of Nippon Kayaku) was applied to the orientation film by a wire bar coater #3. The resulting film was adhered to a metal frame and heated for 2 minutes in a thermostatic bath of 130° C. to orient the discotic compound. The resulting discotic compound was then polymerized by exposure to UV rays for 1 minute at 90° C. by using a 120 W/cm high-pressure mercury lamp and then, was allowed to cool down to room temperature. An optically anisotropic layer was thus formed and an optically compensatory sheet 107 was obtained.

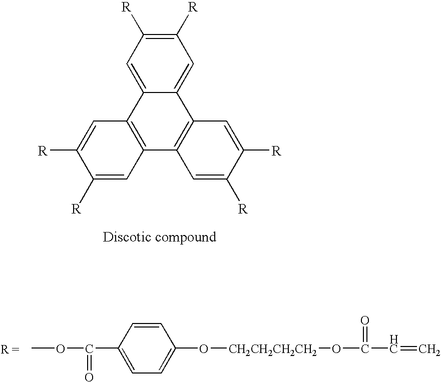

### (Saponification Treatment of the Optically Compensatory Sheet)

In a similar manner to that employed for the above-described saponification treatment B of the cellulose acylate film, the surface of the optically compensatory sheet 107 on the cellulose acylate film side, which was opposite to the optically anisotropic layer formed side, was subjected to saponification treatment.

### (2) Preparation of Polarizing Plate

### (Preparation of Polarizer)

Iodine was adsorbed to a stretched polyvinyl alcohol film to prepare a polarizer. The surface of the optically compensatory sheet 107 on the side of the cellulose acylate film 107 was adhered to one side of the polarizer with a polyvinyl alcohol adhesive so that the slow axis of the cellulose acylate film 107 and the transmission axis of the polarizer became parallel to each other.

A commercially available cellulose triacetate film (“Fujitack TD80UF2”, trade name; product of Fuji Photo Film) was subjected to similar saponification treatment to that employed in Example 6 and the resulting film was adhered to the other side (side onto which the optically compensatory sheet had not been adhered) of the polarizer with a polyvinyl alcohol adhesive. In such a manner, an elliptical polarizing plate 107-2 was prepared.

### Example 13

### Preparation of Liquid Crystal Display Device

### [Preparation of Bend Alignment Liquid Crystal Cell]

A polyimide film was disposed as an orientation film on each of two glass substrates equipped with an ITO electrode and rubbing treatment was given to the orientation film. The resulting two glass plates were faced to each other so that rubbing directions of the films were parallel to each other. A cell gap was set at 5.7 μm. Into the cell gap, a liquid crystal compound (“ZLI 1132”, trade name; product of Merck) having a Δn of 0.1396 was injected, whereby a bend alignment liquid crystal cell was prepared.

### (Preparation of Liquid Crystal Display Device)

Two elliptical polarizing plates 107-2 were adhered to each other with the bend alignment cell sandwiched therebetween. They were placed so that the optically anisotropic layer of the polarizing plate was faced to the cell substrate and the rubbing direction of the liquid cell and the rubbing direction of the optically anisotropic layer facing thereto were antiparallel to each other.

It has been found that the liquid crystal display device using the polarizing plate of the invention had a high contrast and provided a desired image.

### INDUSTRIAL APPLICABILITY

The present invention provides a cellulose acylate film which has a low haze, is excellent in wavelength dispersion characteristics of retardation and can be collected and recycled; and an optically compensatory sheet using the film.

The protective film of a polarizing plate is usually made of a cellulose acylate film. Use of the film of the invention as a protective film for one side of the polarizing plate can add an optically compensatory function to the polarizing plate without increasing the number of constituents of the polarizing plate.

The optically compensatory sheet of the invention and a polarizing plate using the optically compensatory sheet of the present invention as a protective film can be used particularly advantageously for liquid crystal display devices of a VA mode and an OCB mode.

The entire disclosure of each and every foreign patent application from which the benefit of foreign priority has been claimed in the present application is incorporated herein by reference, as if fully set forth.

1. A cellulose acylate film, which has an in-plane retardation (Re) and a retardation in a thickness direction (Rth) satisfying relations of equations (1) to (6) and has a thickness of 30 μm or greater but less than 70 μm:
20 nm<Re(548)<100 nm (1)
100 nm<Rth(548)<400 nm (2)
0.5≦Re(446)/Re(548)≦0.90 (3)
1.05≦Re(629)/Re(548)≦1.50 (4)
0.5≦Rth(446)/Rth(548)≦0.95 (5)
1.05≦Rth(629)/Rth(548)≦1.50 (6).

2. The cellulose acylate film according to claim 1, which has a haze of from 0.1 or greater but not greater than 0.8.

3. The cellulose acylate film according to claim 1,
wherein assuming that a degree of in-plane orientation of a cellulose acylate molecular chain of an entire film thickness is Po and a degree of orientation of a cellulose acylate molecular chain in a thickness direction of the film is Pth, the Po and Pth satisfy relations of equations (7) and (8):
0.040≦Po≦0.10 (7)
0.12≦Pth≦0.40 (8).

4. The cellulose acylate film according to claim 3,
wherein a degree Po of in-plane orientation of a cellulose acylate molecular chain of a film surface and the degree Po of in-plane orientation of the cellulose acylate molecular chain of the entire film thickness satisfy relation of equation (9):
1≦[(Po of the film surface)/(Po of the entire film thickness)]≦1.5 (9).

5. The cellulose acylate film according to claim 1, which is obtained by stretching, at a stretch ratio of 1% or greater but not greater than 100%, a film containing a cellulose acylate having an acylation degree of 2.50 or greater but not greater than 2.90 in at least one of a traveling direction of the film and a direction perpendicular thereto.

6. The cellulose acylate film according to claim 1,
wherein a cellulose acylate of the cellulose acylate film contains two or more acyl groups different in the number of carbon atoms, and assuming that an acyl group having the smallest number of carbon atoms is called Acyl group A and an acyl group having the largest number of carbon atoms is called Acyl group B, degrees of substitution of A and B satisfy relations of equations (10) and (11):
0.1≦(degree of substitution of Acyl group A)≦2.40 (10)
0.1≦(degree of substitution of Acyl group B)≦1.50 (11).

7. The cellulose acylate film according to claim 6,
wherein Acyl group B contains an aromatic structure.

8. The cellulose acylate film according to claim 1, which comprises a plurality of ultraviolet absorbers each having an absorption maximum within a wavelength range of from 250 nm or greater but not greater than 380 nm,
wherein the plurality of ultraviolet absorbers contain at least one ultraviolet absorber having a melting point of 25° C. or less, and
a percentage of an amount of the at least one ultraviolet absorber having a melting point of 25° C. or less is 80 mass % or greater but not greater than 100 mass % based on a total amount of the plurality of ultraviolet absorbers.

9. An optically compensatory sheet, which comprises a cellulose acylate film according to claim 1.

10. The optically compensatory sheet according to claim 9, which further comprises an optically anisotropic layer on the cellulose acylate film.

11. A polarizing plate, which comprises:
a polarization film; and
two transparent protective films located on both sides of the polarization film,
wherein at least one of the two transparent protective films is an optically compensatory sheet according to claim 9.

12. A liquid crystal display device, which comprises:
a liquid crystal cell; and
two polarizing plates located on both sides of the liquid crystal cell,
wherein at least one of the two polarizing plates is a polarizing plate according to claim 11.

13. The liquid crystal display device according to claim 12,
wherein a display mode of the liquid crystal display device is a VA mode.

14. The liquid crystal display device according to claim 12,
wherein a display mode of the liquid crystal display device is an OCB mode.
